(19) United States
(12) Patent Application Publication
(10) Pub. No.: US 2022/0167159 A1
(43) Pub. Date: May 26, 2022

(54) SYSTEMS AND METHODS FOR AUTHENTICATING A WIRELESS DEVICE

(71) Applicant: QUALCOMM Incorporated, San Diego, CA (US)

(72) Inventors: Frankie NING, Superior, CO (US); Vinay PARADKAR, Broomfield, CO (US); Sapna CHITTOOR BRAHMANANDAM, Superior, CO (US); Ohm PATEL, Longmont, CO (US)

(21) Appl. No.: 17/104,936

(22) Filed: Nov. 25, 2020

(51) Int. Cl. H04W 12/06; H04W 12/71

(52) U.S. Cl. CPC H04W 12/06; H04W 12/71

(57) ABSTRACT

Various embodiments include systems and methods for managing communication between a network computing device and a wireless device for performing operations to authenticate the wireless device. As part of an authentication process or procedure, a network computing device may send to a wireless device an identity request that includes an identity request attribute indicating a type of a wireless device identity that is preferred by the network computing device. The wireless may send to the network computing device an identity response based on the acceptable type of wireless device identity indicated in the identity request attribute. The network computing device and the wireless device may then perform authentication operations for the wireless device using the wireless device identity of the acceptable type of wireless device identity.

### BACKGROUND

In Long Term Evolution (LTE) Fifth Generation (5G) New Radio (NR) and other communication technologies, wireless devices must perform an authentication procedure to establish communication with a communication network (e.g., via a base station or other suitable access point). In conventional authentication procedures, such as the Extensible Authentication Protocol (EAP), a network element of a communication network (such as a security function or authentication function) sends a message to a wireless device requesting the wireless device to send an identifier. In response, the wireless device determines an identifier to send to the network. However, the communication network element may not be configured to understand or use the identifier sent by the wireless device. In such cases, the network element may send a second identifier request to the wireless device, and the wireless device may respond with a second identifier. The communication network element and the wireless device may iterate this process a number of times before the wireless device sends a suitable wireless device identifier to the communication network element. Further, aspects of security are left up to the wireless device, such as whether to send a permanent wireless identifier or unencrypted wireless identifier. Interception of such permanent or unencrypted wireless identifier represents a potential security threat to both the wireless device and to the communication network.

### SUMMARY

Various aspects include systems and methods performed by a network computing device for authenticating a wireless device. Various aspects may include sending to the wireless device an identity request including an identity request attribute that indicates an acceptable type of a wireless device identity that is accepted by the network computing device, receiving from the wireless device an identity response including a wireless device identity of the acceptable type of wireless device identity, and performing authentication operations for the wireless device using the received wireless device identity.

In some aspects, the acceptable type of wireless device identity may include an encrypted wireless device identity. In some aspects, the identity request attribute may indicate one or more wireless device identities that are preferred by the network computing device. Some aspects may include determining whether the identity response includes the acceptable type of wireless device identity. In such aspects, performing authentication operations for the wireless device using the received wireless device identity may include performing authentication operations for the wireless device using the received wireless device identity in response to determining that the identity response includes the acceptable type of wireless device identity. Some aspects may include determining whether the wireless device identity is usable to perform authentication operations. In such aspects, performing authentication operations for the wireless device using the received wireless device identity may include performing authentication operations for the wireless device using the received wireless device identity in response to determining that the wireless device identity is usable to perform authentication operations.

In some aspects, sending to the wireless device an identity request including an identity request attribute that indicates an acceptable type of a wireless device identity that is accepted by the network computing device may include sending to the wireless device an identity request including an identity request attribute that indicates a first number of preferred types of wireless device identities preferred by the network computing device. In such aspects, receiving from the wireless device an identity response including a wireless device identity of the acceptable type of wireless device identity may include determining whether the identity response includes one of the first number of preferred types of wireless device identities preferred by the network computing device. In such aspects, performing authentication operations for the wireless device using the received wireless device identity may include performing authentication operations for the wireless device using the received wireless device identity in response to determining that the identity response includes one of the first number of preferred types of wireless device identities.

Some aspects may include sending to the wireless device a second identity request including a second identity request attribute that indicates a second number of preferred types of wireless device identities preferred by the network computing device in response to determining that the identity response does not include one of the first number of preferred types of wireless device identities preferred by the network computing device. In such aspects, the second number of preferred types of wireless device identities may be less than the first number of preferred types of wireless identities preferred by the network computing device.

In some aspects, sending to the wireless device an identity request including an identity request attribute that indicates an acceptable type of a wireless device identity that is preferred by the network computing device may include sending to the wireless device an identity request including an identity request attribute that indicates an acceptable type of a wireless device identity that is preferred by the network computing device other than a permanent wireless device identity. In such aspects, receiving from the wireless device an identity response including a wireless device identity of the acceptable type of wireless device identity may include receiving from the wireless device an identity response including a wireless device identity other than the permanent wireless device identity.

Further aspects include a network computing device having a processor configured to perform one or more operations of any of the methods summarized above. Further aspects include processing devices for use in a network computing device configured with processor-executable instructions to perform operations of any of the methods summarized above. Further aspects include a non-transitory processor-readable storage medium having stored thereon processor-executable instructions configured to cause a processor of a network computing device to perform operations of any of the methods summarized above. Further aspects include a network computing device having means for performing functions of any of the methods summarized above. Further aspects include a system on chip for use in a network computing device and that includes a processor configured to perform one or more operations of any of the methods summarized above.

Various aspects include systems and methods performed by a wireless device for authenticating with a network computing device. Various aspects may include receiving from the network computing device an identity request including an identity request attribute that indicates an acceptable type of wireless device identity, sending to the network computing device an identity response based on the acceptable type of wireless device identity indicated in the identity request attribute in the identity request received from the network computing device, and performing authentication operations with the network computing device using the identity response.

In some aspects, receiving from the network computing device an identity request including an identity request attribute that indicates an acceptable type of wireless device identity may include determining that the identity request attribute in the received identity request indicates an encrypted wireless device identity. In some aspects, sending to the network computing device an identity response based on the acceptable type of wireless device identity indicated in the identity request attribute in the identity request received from the network computing device may include determining whether the wireless device is configured to provide the acceptable type of wireless device identity, and sending to the network computing device the identity response including the acceptable type of wireless device identity in response to determining that the wireless device is configured to provide the acceptable type of wireless device identity.

Some aspects may include sending to the network computing device an identity response including an error attribute in response to determining that the wireless device is not configured to provide the acceptable type of wireless device identity. Some aspects may include determining whether the wireless device has received an indication from the network computing device that the sent wireless device identity is usable for authentication operations, and sending to the network computing device another identity response including another acceptable type of wireless device identity in response to determining that the wireless device has received an indication from the network computing device that the sent wireless device identity is not usable for authentication operations.

Some aspects may include determining whether the identity request attribute indicates two or more acceptable types of wireless device identities, and selecting a wireless device identity of one of the acceptable types of wireless device identities in response to determining that the identity request attribute indicates two or more acceptable types of wireless device identities. In such aspects, sending to the network computing device an identity response based on the acceptable type of wireless device identity indicated in the identity request attribute in the identity request received from the network computing device may include sending the selected wireless device identity to the network computing device.

Some aspects may include determining whether the wireless device has received from the network computing device an indication that the sent wireless device identity is accepted, selecting another wireless device identity of one of the acceptable types of wireless device identities in response to determining that the wireless device has received from the network computing device an indication that the sent wireless device identity is not accepted, and sending the selected another wireless device identity to the network computing device.

Further aspects include a wireless device having a processor configured to perform one or more operations of any of the methods summarized above. Further aspects include processing devices for use in a wireless device configured with processor-executable instructions to perform operations of any of the methods summarized above. Further aspects include a non-transitory processor-readable storage medium having stored thereon processor-executable instructions configured to cause a processor of a wireless device to perform operations of any of the methods summarized above. Further aspects include a wireless device having means for performing functions of any of the methods summarized above. Further aspects include a system on chip for use in a wireless device and that includes a processor configured to perform one or more operations of any of the methods summarized above.

### BRIEF DESCRIPTION OF THE DRAWINGS

The accompanying drawings, which are incorporated herein and constitute part of this specification, illustrate exemplary embodiments of the claims, and together with the general description given above and the detailed description given below, serve to explain the features of the claims.

FIG. 1 is a system block diagram illustrating an example communications system suitable for implementing any of the various embodiments.

FIG. 2 is a component block diagram illustrating an example computing and wireless modem system suitable for implementing any of the various embodiments.

FIG. 3 is a component block diagram illustrating a software architecture including a radio protocol stack for the user and control planes in wireless communications suitable for implementing any of the various embodiments.

FIG. 4A is a component block diagram illustrating components and processing modules of a network computing device suitable for use with various embodiments.

FIG. 4B is a component block diagram illustrating components and processing modules of a wireless device suitable for use with various embodiments.

FIG. 5A is a process flow diagram illustrating a method performed by a processor of a network computing device for authenticating a wireless device according to various embodiments.

FIGS. 5B and 5C illustrate operations that may be performed as part of the method for authenticating a wireless device according to various embodiments.

FIG. 6A is a process flow diagram illustrating a method performed by a processor of a wireless device for authenticating with a network computing device according to various embodiments.

FIGS. 6B and 6C illustrate operations that may be performed by a processor of wireless device as part of the method for authenticating with a network computing device according to various embodiments.

FIG. 7 is a component block diagram of a network computing device suitable for use with various embodiments.

FIG. 8 is a component block diagram of a wireless device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include systems and methods for managing communication between a network computing device and a wireless device and a base station for performing operations to authenticate the wireless device. In some embodiments, as part of an authentication process or procedure, a network computing device (such as a server device, which may include a security function executing on the server device) may send to a wireless device an identity request that includes an identity request attribute. The identity request attribute may indicate a type of a wireless device identity that is accepted by the network computing device (i.e., an acceptable type of a wireless device identity, which may be one or more acceptable types of wireless device identity). The wireless may send to the network computing device an identity response based on the acceptable type of wireless device identity indicated in the identity request attribute (i.e., indicated in the identity request attribute in the identity request received from the network computing device). The network computing device and the wireless device may then perform authentication operations for the wireless device using the wireless device identity of the acceptable type of wireless device identity.

Various embodiments enable the network computing device to control or enforce the security policy by indicating the acceptable type (or types) of wireless device identity to the wireless device. Various embodiments improve the efficiency of authentication processes including reducing a number of iterations that the network computing device and the wireless device may perform to establish an acceptable wireless device identity. Various embodiments improve the efficiency of authentication processes including reducing a number of iterations that the network computing device and the wireless device may perform to determine that a wireless device does not have an acceptable wireless device identity, saving battery power and enabling the wireless device to seek another base station or network access point more quickly.

The term “wireless device” is used herein to refer to any one or all of wireless router devices, wireless appliances, cellular telephones, smartphones, portable computing devices, personal or mobile multi-media players, laptop computers, tablet computers, smartbooks, ultrabooks, palmtop computers, wireless electronic mail receivers, multimedia Internet-enabled cellular telephones, medical devices and equipment, biometric sensors/devices, wearable devices including smart watches, smart clothing, smart glasses, smart wrist bands, smart jewelry (for example, smart rings and smart bracelets), entertainment devices (for example, wireless gaming controllers, music and video players, satellite radios, etc.), wireless-network enabled Internet of Things (IoT) devices including smart meters/sensors, industrial manufacturing equipment, large and small machinery and appliances for home or enterprise use, wireless communication elements within autonomous and semiautonomous vehicles, wireless devices affixed to or incorporated into various mobile platforms, global positioning system devices, and similar electronic devices that include a memory, wireless communication components and a programmable processor.

The term “network computing device” is used herein to refer to a server device or any other suitable computing device that functions as a component of a communications network, as well as one or more security functions that may operate or execute on the computing device. Examples of such security functions include an Authentication Repository and Processing Function (ARPF), a Subscriber Identity De-concealing Function (SIDF), an Authentication Server Function (AUSF), a Security Anchor Function (SEAF), and/or other functions that may be present in a 5G communications network, as well as other analogous computing devices and/or functions that may be present in Third Generation (3G) systems, Fourth Generation (4G) systems, Sixth Generation (6G) systems, or other communications networks or systems.

The term “system on chip” (SOC) is used herein to refer to a single integrated circuit (IC) chip that contains multiple resources or processors integrated on a single substrate. A single SOC may contain circuitry for digital, analog, mixed-signal, and radio-frequency functions. A single SOC also may include any number of general purpose or specialized processors (digital signal processors, modem processors, video processors, etc.), memory blocks (such as ROM, RAM, Flash, etc.), and resources (such as timers, voltage regulators, oscillators, etc.). SOCs also may include software for controlling the integrated resources and processors, as well as for controlling peripheral devices.

The term “system in a package” (SIP) may be used herein to refer to a single module or package that contains multiple resources, computational units, cores or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SOCs coupled together via high speed communication circuitry and packaged in close proximity, such as on a single motherboard or in a single wireless device. The proximity of the SOCs facilitates high speed communications and the sharing of memory and resources.

As used herein, the terms “network,” “system,” “wireless network,” “cellular network,” and “wireless communication network” may interchangeably refer to a portion or all of a wireless network of a carrier associated with a wireless device and/or subscription on a wireless device. The techniques described herein may be used for various wireless communication networks, such as Code Division Multiple Access (CDMA), time division multiple access (TDMA), FDMA, orthogonal FDMA (OFDMA), single carrier FDMA (SC-FDMA) and other networks. In general, any number of wireless networks may be deployed in a given geographic area. Each wireless network may support at least one radio access technology, which may operate on one or more frequency or range of frequencies. For example, a CDMA network may implement Universal Terrestrial Radio Access (UTRA) (including Wideband Code Division Multiple Access (WCDMA) standards), CDMA2000 (including IS-2000, IS-95 and/or IS-856 standards), etc. In another example, a TDMA network may implement GSM Enhanced Data rates for GSM Evolution (EDGE). In another example, an OFDMA network may implement Evolved UTRA (E-UTRA) (including LTE standards), Institute of Electrical and Electronics Engineers (IEEE) 802.11 (WiFi), IEEE 802.16 (WiMAX), IEEE 802.20, Flash-OFDM®, etc. Reference may be made to wireless networks that use LTE standards, and therefore the terms “Evolved Universal Terrestrial Radio Access,” “E-UTRAN” and “eNodeB” may also be used interchangeably herein to refer to a wireless network. However, such references are provided merely as examples, and are not intended to exclude wireless networks that use other communication standards. For example, while various 3G, 4G, and 5G systems are discussed herein, those systems are referenced merely as examples and future generation systems (e.g., 6G or higher systems) may be substituted in the various examples.

In conventional authentication procedures, such as EAP, EAP-AKA (Authentication and Key Agreement), EAP-SIM/AKA (for Subscriber Identity Module (SIM) authentication, EAP-AKA′, EAP-TLS (Transport Layer Security), EAP-TTLS (Tunneled Transport Layer Security), and others, a network element of a communication network (such as a security function or authentication function) sends a message to a wireless device requesting the wireless device to send an identifier. The wireless device typically determines an identifier to send to the network. However, the communication network element may not be configured to understand or use the identifier sent by the wireless device, which may cause the communication network element to send another identifier request to the wireless device. The communication network element and the wireless device may iterate this process a number of times before the wireless device sends a suitable wireless device identifier to the communication network element, causing delay in the authentication process. Further, the wireless device must determine what identifier to send, leaving aspects of wireless device and network security to each individual wireless device. Moreover, the wireless device may send a permanent wireless identifier or unencrypted wireless identifier, the interception of which may pose a security threat to both the wireless device and to the communication network.

Various embodiments include systems and methods for managing communication between a network computing device and a wireless device and a base station for performing operations to authenticate the wireless device. In some embodiments, a network computing device (such as a server device, which may include a security function executing on the server device) may send to a wireless device an identity request that includes an identity request attribute. The identity request attribute may indicate a type of a wireless device identity that is accepted by the network computing device (i.e., an acceptable type of a wireless device identity). In some embodiments, the identity request attribute may indicate a type of wireless device identity (or multiple types of wireless device identities) that are preferred by the network computing device. The wireless device may receive the identity request, and may send to the network computing device an identity response based on the acceptable type of wireless device identity indicated in the identity request attribute (i.e., indicated in the identity request attribute in the identity request received from the network computing device). In some embodiments, the wireless device may send an identity response including a wireless device identity that is preferred by the network computing device. In some embodiments, the wireless device may send an identity response including a wireless device identity that is most preferred by the network computing device. The network computing device may receive from the wireless device the identity response including the wireless device identity of the acceptable type of wireless device identity. The network computing device and the wireless device may then perform authentication operations for the wireless device using the wireless device identity of the acceptable type of wireless device identity.

In some embodiments, the identity request may include an attribute that indicates an acceptable type of wireless identity (or two or more acceptable types of wireless identity). In some embodiments, the attribute may be referred to as AT_PREF_ID_REQ. The attribute may indicate to the wireless device one or more types of wireless device identity that are accepted by the network computing device. In various embodiments, a wireless device may be configured with one or more different identities, including at least a permanent identity, a pseudonym identity, a reauth (or fast-reauth) identity, a Subscription Concealed Identifier (SUCI), a Subscription Permanent Identifier (SUPI), an encrypted International Mobile Subscriber Identity (IMSI), and/or a vendor-specific wireless device identity type. In some embodiments, the attribute may indicate two or more acceptable types of wireless device identity. In some embodiments, the attribute may indicate an order, rank, or other indication of preference of the two or more acceptable types of wireless device identity (e.g., most preferred, next most preferred, and so forth).

In some embodiments, the identity request may include one or more additional attributes, such as AT_PERMANENT_ID_REQ, AT_FULLAUTH_ID_REQ, and/or AT_ANY_ID_REQ. In some embodiments, the attribute that indicates the acceptable type of wireless identity (e.g., AT_PREF_ID_REQ) may be used in coexistence with other identity request attributes, including existing identity request attributes. In some embodiments, a wireless device that is not configured to recognize or process the attribute that indicates the acceptable type of wireless identity (e.g., AT_PREF_ID_REQ) may recognize or process another attribute (e.g., one of the additional attributes). In some embodiments, a wireless device that is configured to recognize or process the attribute that indicates the acceptable type of wireless identity (e.g., AT_PREF_ID_REQ) may recognize or process that attribute preferentially (e.g., instead of) another attribute.

Various embodiments enable the network computing device to control or enforce aspects of security, such as a security policy, through a mechanism of indicating to the wireless device what type(s) of wireless device identities are accepted (or preferred) by the network computing device. Sending the permanent identity can be a security risk to the wireless device and to the communication network because the permanent identity may be intercepted by a man in the middle, especially over unencrypted communications. In some embodiments, the wireless device may select from one or more types of wireless device identity indicated in the attribute. In some embodiments, if the attribute does not indicate the wireless device's permanent identity, the wireless device may not send the permanent identity. In some embodiments, if the attribute does not indicate the wireless device's permanent identity, the wireless device may determine that such absence in the attribute is an indication to the wireless device not to send the wireless device's permanent identity (and the wireless device will not send its permanent identity in such case). In this manner, various embodiments make the wireless device authentication process more secure. Further, various embodiments improve the efficiency of the wireless device authentication process including reducing a number of iterations the network computing device and the wireless device may perform before the network computing device receives an acceptable wireless device identity.

As noted above, in some embodiments, the attribute may include one, two, or more acceptable wireless identity types. In some embodiments, the attribute may indicate the wireless identity types (e.g., listed or otherwise indicated) in an order of preference (e.g., a most preferred wireless identity type first, a second most preferred wireless identity type second, and so forth). In some embodiments, a value of zero may be invalid as an indicator of an identity type, but may serve as an integrity check on the attribute. In some embodiments, each wireless identity type may be identified by a single byte.

In some embodiments, the network computing device may determine whether the identity response includes the acceptable type of wireless device identity. In response to determining that the identity response includes the acceptable type of wireless device, the network computing device may perform authentication operations for the wireless device using the received wireless device identity. In some embodiments, the network computing device may be configured to accept only a wireless device identity type that the network computing device has indicated to the wireless device in the attribute. In some embodiments, the network computing device may be configured to reject a wireless device identity type received from the wireless device that was not indicated to the wireless device in the attribute.

In some embodiments, the network computing device may send to the wireless device an identity request including an identity request attribute that indicates a first number of preferred types of wireless device identities preferred by the network computing device. In such embodiments, the network computing device may receive the identity response from the wireless device and may determine whether the identity response includes one of the first number of preferred types of wireless device identities preferred by the network computing device. In such embodiments, the network computing device may perform authentication operations for the wireless device using the received wireless device identity in response to determining that the identity response includes at least one of the first number of preferred types of wireless device identities.

In some embodiments, in response to determining that the identity response does not include at least one of the first number of preferred types of wireless device identities preferred by the network computing device, the network computing device may send a second identity request including a second identity request attribute that indicates a second number of preferred types of wireless device identities preferred by the network computing device. In such embodiments, the second number preferred types of wireless device identities may be less than the first number of preferred types of wireless identities preferred by the network computing device. In this manner, the network computing device may gradually reduce a number of choices of wireless device identities indicated by the attribute, which may increase efficiency and reduce a number of communication iterations performed by the network computing device and the wireless device. In some embodiments, the network computing device may be limited to the sending a threshold number of identity requests to the wireless device (for example, no more than three identity requests). In some embodiments, the network computing device may be configured to indicate only one wireless device identity type in a last identity request.

In some embodiments, the network computing device may send to the wireless device an identity request including an identity request attribute that indicates an acceptable type of a wireless device identity that is preferred by the network computing device other than a permanent wireless device identity (e.g., an IMSI). In such embodiments, the network computing device may receive from the wireless device an identity response including a wireless device identity other than the permanent wireless device identity. For example, the network computing device may explicitly indicate to the wireless device one or more wireless device identity types other than the permanent wireless device identity. In this manner, the network computing device may attempt to prevent the wireless device from sending its permanent wireless device identity to the network computing device.

In some embodiments, the wireless device may determine whether the wireless device is configured to provide the acceptable type of wireless device identity that is indicated in the attribute from the network computing device. In some embodiments, the processor may determine whether the wireless device is configured to recognize, or configured to support, the identity request attribute that indicates an acceptable type of wireless device identity. In response to determining that the wireless device is not configured to provide the acceptable type of wireless device identity, the wireless device may send to the network computing device an error attribute. In response to determining that the wireless device is configured to provide the acceptable type of wireless device identity in determination, the wireless device may send to the network computing device an identity response including the acceptable type of wireless device identity.

In some embodiments, the wireless device may determine whether the wireless device receives an indication from the network computing device that the wireless device identity is usable for authentication operations. In response to determining that the wireless device identity is not usable for authentication operations, the wireless device may determine whether another wireless device identity is available to the wireless device (e.g., the processor may determine whether the wireless device is configured with another wireless device identity). In some embodiments, the wireless device may determine whether the wireless device is configured with another wireless device identity that is identified as acceptable in the identity request attribute. In response to determining that another wireless device identity is available to the wireless device, the wireless device may send another wireless device identity (i.e., of an acceptable type) to the network computing device. In response to determining that another wireless device identity is not available to the wireless device, the wireless device may send to the network computing device an error attribute, such as an identity response including an error attribute (or another suitable indication of an error.

In some embodiments, the wireless device may determine whether the identity request attribute included in the identity request indicates two or more acceptable types of wireless device identity. In response to determining that the identity request attribute included in the identity request indicates two or more acceptable types of wireless device identity, the wireless device may select (e.g., from a memory of the wireless device) a wireless device identity that is one of the acceptable types of wireless device identity. In some embodiments, the identity request attribute may indicate the two or more acceptable types of wireless device identity in a list or order, such as an order of preference.

In some embodiments, the wireless device may select a most preferred type of wireless device identity as indicated by the identity request attribute (e.g., where the attribute indicates the acceptable types of wireless device identities in an order of preference). The wireless device may send to the network computing device an identity response including the selected acceptable type of wireless device identity. The wireless device then may determine whether the wireless device receives an indication from the network computing device that the wireless device identity sent to the network computing device is accepted. In response to determining that the wireless device has received an indication from the network computing device that the sent wireless device identity is not accepted, the wireless device may determine whether another acceptable type of wireless device identity is available to the wireless device. For example, the processor may determine whether the wireless device is configured with another wireless device identity that is indicated as acceptable in the identity request attribute. In response to determining that another wireless device identity is available to the wireless device, the wireless device may send another wireless device identity of an acceptable type to the network computing device. In some embodiments, the wireless device may select a next wireless device identity of a type that the identity request attribute indicates in an order of preference. In this manner, the wireless device may iterate through a list or order of preference of the types of wireless device identities, as may be indicated in the attribute.

In some embodiments, the attribute may be configured to support backward compatibility. For example, various network computing devices and various wireless devices may be configured to use different wireless device identities. The number and use of such wireless device identities may vary dramatically, and may include one or more types of vendor-defined wireless device identities. Further, more generally-used standardized identities may change over time. For example, new identity types may be added to a technical standard, or definition and/or configuration of existing identity types may be changed in the technical standard. Through use of the attribute that indicates an acceptable type of a wireless device identity that is preferred by the network computing device, regardless of whether a network computing device or a wireless device is configured with older or newer wireless device identities, configuring an identity request with the attribute may enable the network computing device and the wireless device to rapidly determine an acceptable wireless device identity to use for authentication procedures. In this manner, network computing devices and wireless device may be gradually configured to support for use of the attribute in an identity request without requiring an update to every device in a communications network.

In some embodiments, any identity type that is not defined in a technical standard (e.g., an Internet Assigned Numbers Authority (IANA) specification or another suitable technical specification or standard) may be defined by carrier or network provider and used to communicate a vendor-specific identity type. New identity types may be defined in the future to indicate new identity types, such as encrypted identity type(s). If a carrier or network provider-defined identity type is later adopted in a technical specification, such identity types may be defined in an identity type range that is not allocated for carrier or network provider definition. In some embodiments, the attribute may indicate the version of an identity type that is acceptable. In some embodiments, a definition of the attribute (e.g., in a technical specification or standard) may define certain identity types, and may reserve some identity types to be defined by a carrier or network provider. For example, identity types 1-127 may be defined in a technical specification or standard (e.g., IANA) and identity types 128-255 may be reserved for definition by a carrier or network provider. In this manner, a carrier or network provider may use the attribute to define and deploy the use of an identity type, such as an encrypted identity type (e.g., encrypted IMSI) before such identity type is incorporated into a technical specification or standard.

In some embodiments, the attribute may be defined as a “skippable” attribute such that if a wireless device does not understand the attribute (e.g., if a wireless device is not configured to recognize or process the attribute), the wireless device may ignore it and perform other operations of the authentication process. In some embodiments, the wireless device may be configured to process another attribute in response to determining that the wireless device does not understand the attribute, such as in response to determining that the wireless device is not configured to recognize or process the attribute. Defining the attribute as skippable may facilitate a gradual rollout of network computing device configurations and wireless device configurations that support use of the attribute.

In some embodiments, the attribute may be used in security gateways and similar functions (e.g., an evolved Packet Data Gateway (ePDG) or another suitable network security gateway or other function). For example, some communication network operators may require a device Media Access Control (MAC) address to be decorated into a device's permanent identity for use by a security gateway/function. As another example, a network operator may add roaming Public Land Mobile Network (PLMN) with a wireless device identity. Such decoration may be accomplished by defining a new identity type, which may be requested by a network computing device in the attribute. In such implementations, network computing devices and wireless device may be configured with such new defined identity type(s). In various embodiments, the attribute may be used in devices with relatively limited processing capabilities (e.g., Internet of Things devices) and may be used for EAP-TLS, EAP-TTLS, and other suitable protocols.

For conciseness, this description focuses on a network computing device and a wireless device using an identity request in an EAP layer, but this is not intended as, and should not be construed as, a limitation. In various embodiments, an identity request may include a signal via EAP transport, IKEV2 (Internet Key Exchange version 2) transport, NAS (Non-Access Stratum) transport, or other methods or techniques of transport, prior to or during EAP authentication. In some embodiments, the attribute may include an EAP attribute. In some embodiments, one or more accepted may be provided in an IKEV2 payload prior to EAP authentication (e.g., iWLAN (Interworking Wireless Local Area Network), ePDG (evolved Packet Data Gateway), and the like). For some 5G NR systems, the attribute may be included in NAS signaling such as a NAS optional PCO (Protocol Configuration Option) that may indicate an acceptable wireless device identity type. References to EAP include EAP RFC (Request for Comment) 3748, EAP SIM/AKA/AKA′ RFC 4186, RFC 4187, and RFC 5448.

Various embodiments improve the operations of network computing devices and wireless devices by improving control over security and privacy policy enforcement. Various embodiments improve the efficiency of network computing devices and wireless devices by reducing a number of messages and/or iterations of various authentication operations, and by reducing or eliminating messages from a wireless device that include a wireless device identity that is not supported by a network computing device.

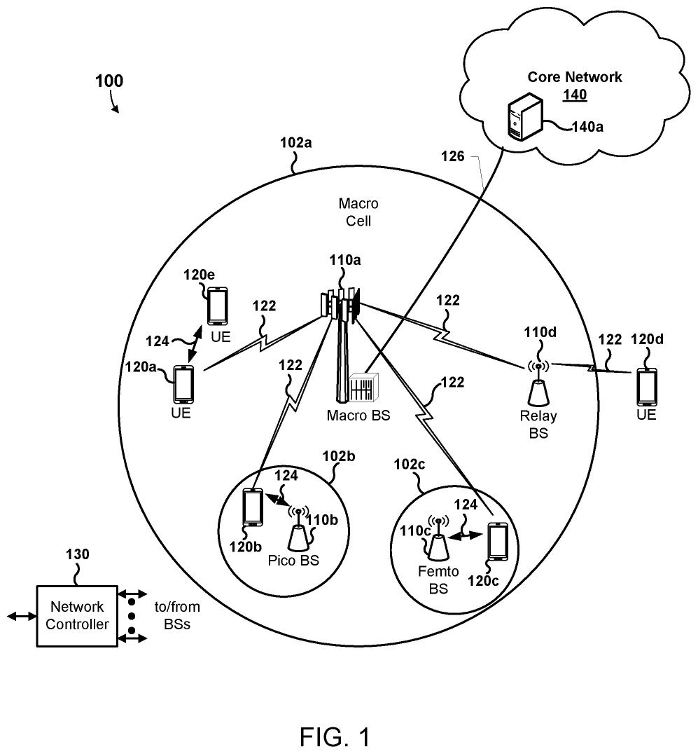

FIG. 1 is a system block diagram illustrating an example communications system 100. The communications system 100 may be a 5G New Radio (NR) network, or any other suitable network such as a Long Term Evolution (LTE) network. While FIG. 1 illustrates a 5G network, later generation networks may include the same or similar elements. Therefore, the reference to a 5G network and 5G network elements in the following descriptions is for illustrative purposes and is not intended to be limiting.

The communications system 100 may include a heterogeneous network architecture that includes a core network 140 and a variety of wireless devices (illustrated as wireless devices 120a-120e in FIG. 1). The communications system 100 also may include a number of base stations (illustrated as the BS 110a, the BS 110b, the BS 110c, and the BS 110d) and other network entities. A base station is an entity that communicates with wireless devices, and also may be referred to as a Node B, an LTE Evolved nodeB (eNodeB or eNB), an access point (AP), a Radio head, a transmit receive point (TRP), a New Radio base station (NR BS), a 5G NodeB (NB), a Next Generation NodeB (gNodeB or gNB), or the like. Each base station may provide communication coverage for a particular geographic area. In 3GPP, the term “cell” can refer to a coverage area of a base station, a base station subsystem serving this coverage area, or a combination thereof, depending on the context in which the term is used. The core network 140 may be any type core network, such as an LTE core network (e.g., an EPC network), 5G core network, etc. The core network 140 may include one or more network computing devices 140a. A network computing device 140a may perform a variety of operations and/or execute a variety of functions, including at least one or more of an ARPF, an SIDF, an AUSF, an SEAF, and/or other functions or analogous functions that may be provided by or may be executed in a communications network.

A base station 110a-110d may provide communication coverage for a macro cell, a pico cell, a femto cell, another type of cell, or a combination thereof. A macro cell may cover a relatively large geographic area (for example, several kilometers in radius) and may allow unrestricted access by wireless devices with service subscription. A pico cell may cover a relatively small geographic area and may allow unrestricted access by wireless devices with service subscription. A femto cell may cover a relatively small geographic area (for example, a home) and may allow restricted access by wireless devices having association with the femto cell (for example, wireless devices in a closed subscriber group (CSG)). A base station for a macro cell may be referred to as a macro BS. A base station for a pico cell may be referred to as a pico BS. A base station for a femto cell may be referred to as a femto BS or a home BS. In the example illustrated in FIG. 1, a base station 110a may be a macro BS for a macro cell 102a, a base station 110b may be a pico BS for a pico cell 102b, and a base station 110c may be a femto BS for a femto cell 102c. A base station 110a-110d may support one or multiple (for example, three) cells. The terms “eNB”, “base station”, “NR BS”, “gNB”, “TRP”, “AP”, “node B”, “5G NB”, and “cell” may be used interchangeably herein.

In some examples, a cell may not be stationary, and the geographic area of the cell may move according to the location of a mobile base station. In some examples, the base stations 110a-110d may be interconnected to one another as well as to one or more other base stations or network nodes (not illustrated) in the communications system 100 through various types of backhaul interfaces, such as a direct physical connection, a virtual network, or a combination thereof using any suitable transport network

The base station 110a-110d may communicate with the core network 140 over a wired or wireless communication link 126. The wireless device 120a-120e may communicate with the base station 110a-110d over a wireless communication link 122.

The wired communication link 126 may use a variety of wired networks (such as Ethernet, TV cable, telephony, fiber optic and other forms of physical network connections) that may use one or more wired communication protocols, such as Ethernet, Point-To-Point protocol, High-Level Data Link Control (HDLC), Advanced Data Communication Control Protocol (ADCCP), and Transmission Control Protocol/Internet Protocol (TCP/IP).

The communications system 100 also may include relay stations (such as relay BS 110d). A relay station is an entity that can receive a transmission of data from an upstream station (for example, a base station or a wireless device) and send a transmission of the data to a downstream station (for example, a wireless device or a base station). A relay station also may be a wireless device that can relay transmissions for other wireless devices. In the example illustrated in FIG. 1, a relay station 110d may communicate with macro the base station 110a and the wireless device 120d in order to facilitate communication between the base station 110a and the wireless device 120d. A relay station also may be referred to as a relay base station, a relay base station, a relay, etc.

The communications system 100 may be a heterogeneous network that includes base stations of different types, for example, macro base stations, pico base stations, femto base stations, relay base stations, etc. These different types of base stations may have different transmit power levels, different coverage areas, and different impacts on interference in communications system 100. For example, macro base stations may have a high transmit power level (for example, 5 to 40 Watts) whereas pico base stations, femto base stations, and relay base stations may have lower transmit power levels (for example, 0.1 to 2 Watts).

A network controller 130 may couple to a set of base stations and may provide coordination and control for these base stations. The network controller 130 may communicate with the base stations via a backhaul. The base stations also may communicate with one another, for example, directly or indirectly via a wireless or wireline backhaul.

The wireless devices 120a, 120b, 120c may be dispersed throughout communications system 100, and each wireless device may be stationary or mobile. A wireless device also may be referred to as an access terminal, a terminal, a mobile station, a subscriber unit, a station, user equipment (UE), etc.

A macro base station 110a may communicate with the communication network 140 over a wired or wireless communication link 126. The wireless devices 120a, 120b, 120c may communicate with a base station 110a-110d over a wireless communication link 122.

The wireless communication links 122 and 124 may include a plurality of carrier signals, frequencies, or frequency bands, each of which may include a plurality of logical channels. The wireless communication links 122 and 124 may utilize one or more radio access technologies (RATs). Examples of RATs that may be used in a wireless communication link include 3GPP LTE, 3G, 4G, 5G (such as NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication system 100 include medium range protocols such as Wi-Fi, LTE-U, LTE-Direct, LAA, MuLTEfire, and relatively short range RATs such as ZigBee, Bluetooth, and Bluetooth Low Energy (LE).

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block”) may be 12 subcarriers (or 180 kHz). Consequently, the nominal Fast File Transfer (FFT) size may be equal to 128, 256, 512, 1024 or 2048 for system bandwidth of 1.25, 2.5, 5, 10 or 20 megahertz (MHz), respectively. The system bandwidth also may be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHz, respectively.

While descriptions of some implementations may use terminology and examples associated with LTE technologies, some implementations may be applicable to other wireless communications systems, such as a new radio (NR) or 5G network. NR may utilize OFDM with a cyclic prefix (CP) on the uplink (UL) and downlink (DL) and include support for half-duplex operation using time division duplex (TDD). A single component carrier bandwidth of 100 MHz may be supported. NR resource blocks may span 12 sub-carriers with a sub-carrier bandwidth of 75 kHz over a 0.1 millisecond (ms) duration. Each radio frame may consist of 50 subframes with a length of 10 ms. Consequently, each subframe may have a length of 0.2 ms. Each subframe may indicate a link direction (i.e., DL or UL) for data transmission and the link direction for each subframe may be dynamically switched. Each subframe may include DL/UL data as well as DL/UL control data. Beamforming may be supported and beam direction may be dynamically configured. Multiple Input Multiple Output (MIMO) transmissions with precoding also may be supported. MIMO configurations in the DL may support up to eight transmit antennas with multi-layer DL transmissions up to eight streams and up to two streams per wireless device. Multi-layer transmissions with up to 2 streams per wireless device may be supported.

Aggregation of multiple cells may be supported with up to eight serving cells. Alternatively, NR may support a different air interface, other than an OFDM-based air interface.

Some wireless devices may be considered machine-type communication (MTC) or evolved or enhanced machine-type communication (eMTC) wireless devices. MTC and eMTC wireless devices include, for example, robots, drones, remote devices, sensors, meters, monitors, location tags, etc., that may communicate with a base station, another device (for example, remote device), or some other entity. A wireless computing platform may provide, for example, connectivity for or to a network (for example, a wide area network such as Internet or a cellular network) via a wired or wireless communication link. Some wireless devices may be considered Internet-of-Things (IoT) devices or may be implemented as NB-IoT (narrowband internet of things) devices. The wireless device 120a-120e may be included inside a housing that houses components of the wireless device 120a-120e, such as processor components, memory components, similar components, or a combination thereof.

In general, any number of communications systems and any number of wireless networks may be deployed in a given geographic area. Each communications system and wireless network may support a particular radio access technology (RAT) and may operate on one or more frequencies. A RAT also may be referred to as a radio technology, an air interface, etc. A frequency also may be referred to as a carrier, a frequency channel, etc. Each frequency may support a single RAT in a given geographic area in order to avoid interference between communications systems of different RATs. In some cases, 4G/LTE and/or 5G/NR RAT networks may be deployed. For example, a 5G non-standalone (NSA) network may utilize both 4G/LTE RAT in the 4G/LTE RAN side of the 5G NSA network and 5G/NR RAT in the 5G/NR RAN side of the 5G NSA network. The 4G/LTE RAN and the 5G/NR RAN may both connect to one another and a 4G/LTE core network (e.g., an evolved packet core (EPC) network) in a 5G NSA network. Other example network configurations may include a 5G standalone (SA) network in which a 5G/NR RAN connects to a 5G core network.

In some implementations, two or more wireless devices (for example, illustrated as the wireless device 120a and the wireless device 120e) may communicate directly using one or more sidelink channels (for example, without using a base station 110a-d as an intermediary to communicate with one another). For example, the wireless devices 120a-e may communicate using peer-to-peer (P2P) communications, device-to-device (D2D) communications, a vehicle-to-everything (V2X) protocol (which may include a vehicle-to-vehicle (V2V) protocol, a vehicle-to-infrastructure (V2I) protocol, or similar protocol), a mesh network, or similar networks, or combinations thereof. In this case, the wireless device 120a-120e may perform scheduling operations, resource selection operations, as well as other operations described elsewhere herein as being performed by the base station 110a-110d.

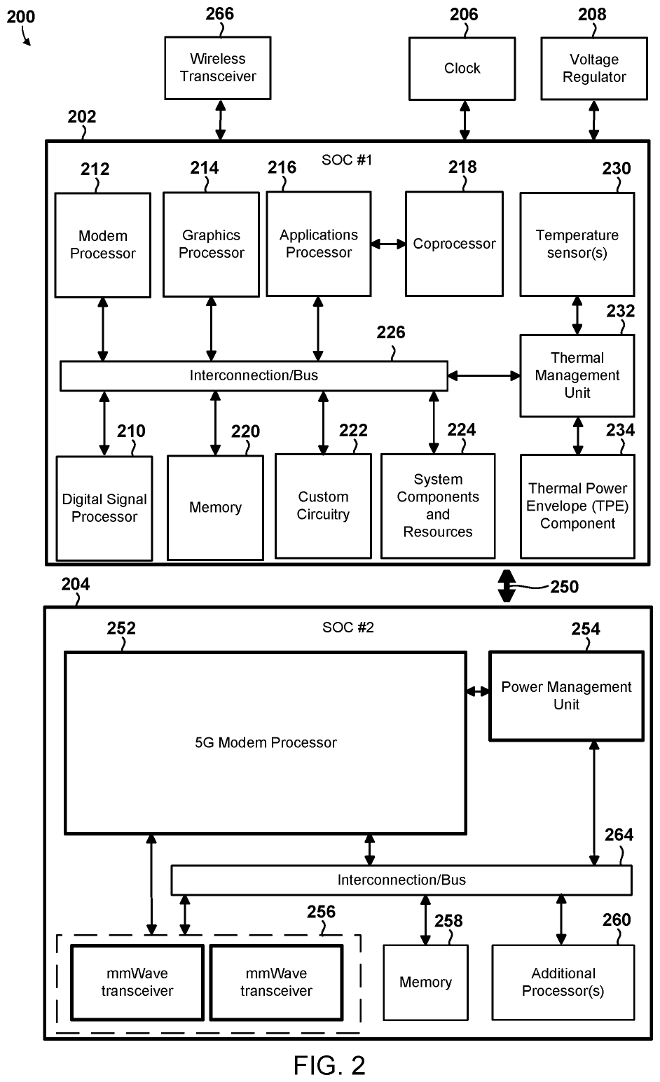

FIG. 2 is a component block diagram illustrating an example computing and wireless modem system 200 suitable for implementing any of the various embodiments. Various embodiments may be implemented on a number of single processor and multiprocessor computer systems, including a system-on-chip (SOC) or system in a package (SIP).

With reference to FIGS. 1 and 2, the illustrated example computing system 200 (which may be a SIP in some embodiments) includes a two SOCs 202, 204 coupled to a clock 206, a voltage regulator 208, and a wireless transceiver 266 configured to send and receive wireless communications via an antenna (not shown) to/from wireless devices, such as a base station 110a. In some implementations, the first SOC 202 may operate as central processing unit (CPU) of the wireless device that carries out the instructions of software application programs by performing the arithmetic, logical, control and input/output (I/O) operations specified by the instructions. In some implementations, the second SOC 204 may operate as a specialized processing unit. For example, the second SOC 204 may operate as a specialized 5G processing unit responsible for managing high volume, high speed (such as 5 Gbps, etc.), or very high frequency short wave length (such as 28 GHz mmWave spectrum, etc.) communications.

The first SOC 202 may include a digital signal processor (DSP) 210, a modem processor 212, a graphics processor 214, an application processor 216, one or more coprocessors 218 (such as vector co-processor) connected to one or more of the processors, memory 220, custom circuitry 222, system components and resources 224, an interconnection/bus module 226, one or more temperature sensors 230, a thermal management unit 232, and a thermal power envelope (TPE) component 234. The second SOC 204 may include a 5G modem processor 252, a power management unit 254, an interconnection/bus module 264, a plurality of mmWave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SOC 202 may include a processor that executes a first type of operating system (such as FreeBSD, LINUX, OS X, etc.) and a processor that executes a second type of operating system (such as MICROSOFT WINDOWS 10). In addition, any or all of the processors 210, 212, 214, 216, 218, 252, 260 may be included as part of a processor cluster architecture (such as a synchronous processor cluster architecture, an asynchronous or heterogeneous processor cluster architecture, etc.).

The first and second SOC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, access ports, timers, and other similar components used to support the processors and software clients running on a wireless device. The system components and resources 224 or custom circuitry 222 also may include circuitry to interface with peripheral devices, such as cameras, electronic displays, wireless communication devices, external memory chips, etc.

The first and second SOC 202, 204 may communicate via interconnection/bus module 250. The various processors 210, 212, 214, 216, 218, may be interconnected to one or more memory elements 220, system components and resources 224, and custom circuitry 222, and a thermal management unit 232 via an interconnection/bus module 226. Similarly, the processor 252 may be interconnected to the power management unit 254, the mmWave transceivers 256, memory 258, and various additional processors 260 via the interconnection/bus module 264. The interconnection/bus module 226, 250, 264 may include an array of reconfigurable logic gates or implement a bus architecture (such as CoreConnect, AMBA, etc.). Communications may be provided by advanced interconnects, such as high-performance networks-on chip (NoCs).

The first or second SOCs 202, 204 may further include an input/output module (not illustrated) for communicating with resources external to the SOC, such as a clock 206 and a voltage regulator 208. Resources external to the SOC (such as clock 206, voltage regulator 208) may be shared by two or more of the internal SOC processors/cores.

In addition to the example SIP 200 discussed above, some implementations may be implemented in a wide variety of computing systems, which may include a single processor, multiple processors, multicore processors, or any combination thereof.

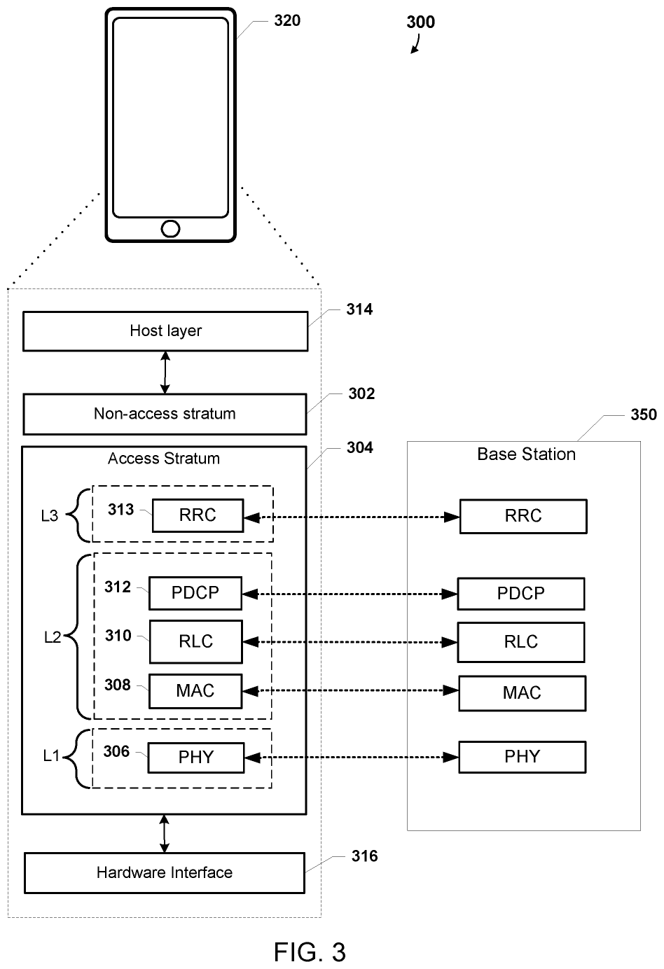

FIG. 3 is a component block diagram illustrating a software architecture 300 including a radio protocol stack for the user and control planes in wireless communications suitable for implementing any of the various embodiments. With reference to FIGS. 1-3, the wireless device 320 may implement the software architecture 300 to facilitate communication between a wireless device 320 (e.g., the wireless device 120a-120e, 200) and the base station 350 (e.g., the base station 110a-110d) of a communication system (e.g., 100). In various embodiments, layers in software architecture 300 may form logical connections with corresponding layers in software of the base station 350. The software architecture 300 may be distributed among one or more processors (e.g., the processors 212, 214, 216, 218, 252, 260). While illustrated with respect to one radio protocol stack, in a multi-SIM (subscriber identity module) wireless device, the software architecture 300 may include multiple protocol stacks, each of which may be associated with a different SIM (e.g., two protocol stacks associated with two SIMs, respectively, in a dual-SIM wireless communication device). While described below with reference to LTE communication layers, the software architecture 300 may support any of variety of standards and protocols for wireless communications, and/or may include additional protocol stacks that support any of variety of standards and protocols wireless communications.

The software architecture 300 may include a Non-Access Stratum (NAS) 302 and an Access Stratum (AS) 304. The NAS 302 may include functions and protocols to support packet filtering, security management, mobility control, session management, and traffic and signaling between a SIM(s) of the wireless device (such as SIM(s) 204) and its core network 140. The AS 304 may include functions and protocols that support communication between a SIM(s) (such as SIM(s) 204) and entities of supported access networks (such as a base station). In particular, the AS 304 may include at least three layers (Layer 1, Layer 2, and Layer 3), each of which may contain various sub-layers.

In the user and control planes, Layer 1 (L1) of the AS 304 may be a physical layer (PHY) 306, which may oversee functions that enable transmission or reception over the air interface via a wireless transceiver (e.g., 266). Examples of such physical layer 306 functions may include cyclic redundancy check (CRC) attachment, coding blocks, scrambling and descrambling, modulation and demodulation, signal measurements, MIMO, etc. The physical layer may include various logical channels, including the Physical Downlink Control Channel (PDCCH) and the Physical Downlink Shared Channel (PDSCH).

In the user and control planes, Layer 2 (L2) of the AS 304 may be responsible for the link between the wireless device 320 and the base station 350 over the physical layer 306. In some implementations, Layer 2 may include a media access control (MAC) sublayer 308, a radio link control (RLC) sublayer 310, and a packet data convergence protocol (PDCP) 312 sublayer, each of which form logical connections terminating at the base station 350.

In the control plane, Layer 3 (L3) of the AS 304 may include a radio resource control (RRC) sublayer 3. While not shown, the software architecture 300 may include additional Layer 3 sublayers, as well as various upper layers above Layer 3. In some implementations, the RRC sublayer 313 may provide functions including broadcasting system information, paging, and establishing and releasing an RRC signaling connection between the wireless device 320 and the base station 350.

In some implementations, the PDCP sublayer 312 may provide uplink functions including multiplexing between different radio bearers and logical channels, sequence number addition, handover data handling, integrity protection, ciphering, and header compression. In the downlink, the PDCP sublayer 312 may provide functions that include in-sequence delivery of data packets, duplicate data packet detection, integrity validation, deciphering, and header decompression.

In the uplink, the RLC sublayer 310 may provide segmentation and concatenation of upper layer data packets, retransmission of lost data packets, and Automatic Repeat Request (ARQ). In the downlink, while the RLC sublayer 310 functions may include reordering of data packets to compensate for out-of-order reception, reassembly of upper layer data packets, and ARQ.

In the uplink, MAC sublayer 308 may provide functions including multiplexing between logical and transport channels, random access procedure, logical channel priority, and hybrid-ARQ (HARQ) operations. In the downlink, the MAC layer functions may include channel mapping within a cell, de-multiplexing, discontinuous reception (DRX), and HARQ operations.

While the software architecture 300 may provide functions to transmit data through physical media, the software architecture 300 may further include at least one host layer 314 to provide data transfer services to various applications in the wireless device 320. In some implementations, application-specific functions provided by the at least one host layer 314 may provide an interface between the software architecture and the general purpose processor 206.

In other implementations, the software architecture 300 may include one or more higher logical layer (such as transport, session, presentation, application, etc.) that provide host layer functions. For example, in some implementations, the software architecture 300 may include a network layer (such as Internet protocol (IP) layer) in which a logical connection terminates at a packet data network (PDN) gateway (PGW). In some implementations, the software architecture 300 may include an application layer in which a logical connection terminates at another device (such as end user device, server, etc.). In some implementations, the software architecture 300 may further include in the AS 304 a hardware interface 316 between the physical layer 306 and the communication hardware (such as one or more radio frequency (RF) transceivers).

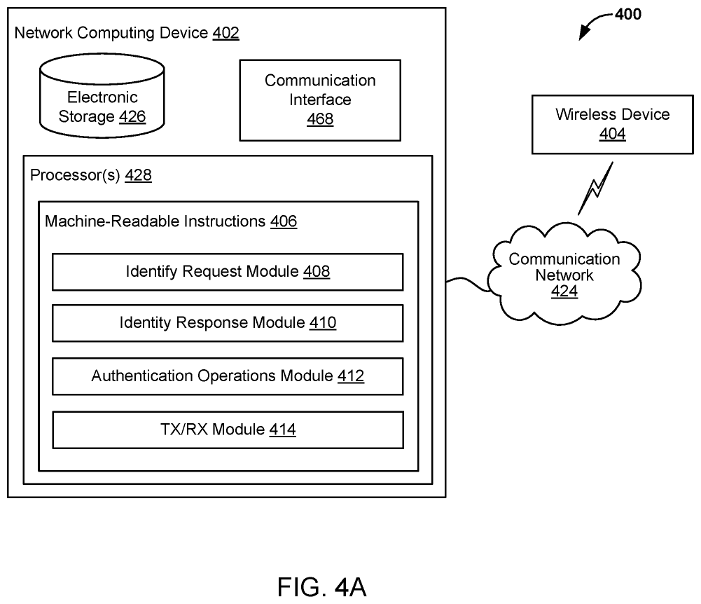

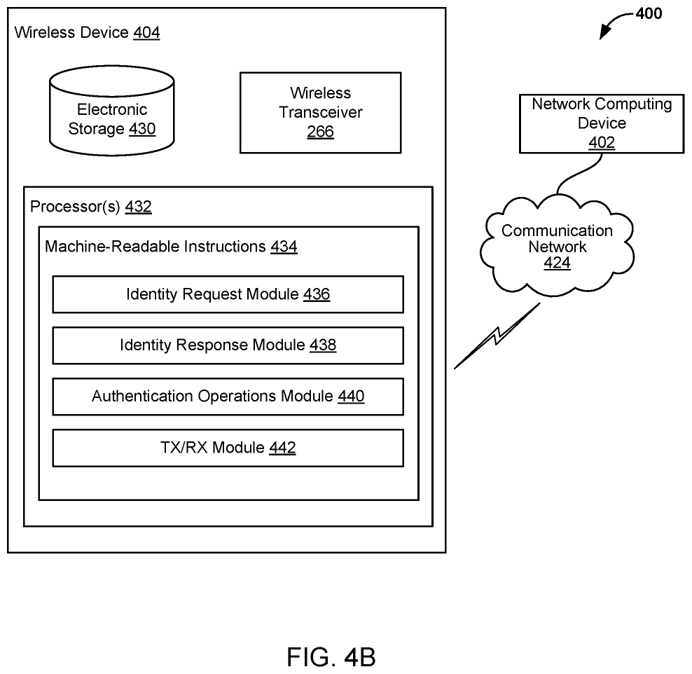

FIGS. 4A and 4B are component block diagrams illustrating a system 400 configured for authenticating a wireless device in accordance with various embodiments. With reference to FIGS. 1-4B, system 400 may include a network computing device 402 (e.g., 104a, 200) and a wireless device 404 (e.g., 110a-110d, 120a-120e, 200, 320).

The network computing device 402 may include one or more processors 428 coupled to electronic storage 426 and a communication interface 468. The wireless device 404 may include one or more processors 432 coupled to electronic storage 430 and a wireless transceiver 266. The wireless transceiver 266 and the network interface 468 may be configured to receive messages sent in transmissions and pass such message to the processor(s) 428, 432 for processing. Similarly, the processor 428, 432 may be configured to send messages for transmission to the wireless transceiver 266 or the network interface 468 for transmission.

Referring to the network computing device 402, the processor(s) 428 may be configured by machine-readable instructions 406. Machine-readable instructions 406 may include one or more instruction modules. The instruction modules may include computer program modules. The instruction modules may include at least one or more of an identity request module 408, an identity response module 410, an authentication operations module 412, and a transmit/receive (TX/RX) module 414.

The identity request module 408 may be configured to send to the wireless device an identity request including an identity request attribute that indicates an acceptable type of a wireless device identity that is preferred by the network computing device.

The identity response module 410 may be configured to receive from the wireless device an identity response that includes a wireless device identity of the acceptable type of wireless device identity.

The authentication operations module 412 may be configured to perform authentication operations for the wireless device using the received wireless device identity.

The transmit/receive (TX/RX) module 414 may be configured to control the transmission and reception of wireless communications with the wireless device 402, e.g., via the communication interface 468.

Referring to the computing device 404, the processor(s) 432 may be configured by machine-readable instructions 434. Machine-readable instructions 406 may include one or more instruction modules. The instruction modules may include computer program modules. The instruction modules may include at least one or more of an identity request module 436, an identity response module 438, an authentication operations module 440, and a TX/RX module 446.

The identity request module 436 may be configured to receive from the network computing device an identity request including an identity request attribute that indicates an acceptable type of wireless device identity.

The identity response module 438 may be configured to send to the network computing device an identity response based on the acceptable type of wireless device identity indicated in the identity request attribute in the identity request received from the network computing device.

The authentication operations module 440 may be configured to perform authentication operations for the wireless device using the received wireless device identity.

The TX/RX module 446 may be configured to enable communications with the network computing device 402, e.g., via the wireless transceiver 266.

In some embodiments, the network computing device 402 and the wireless device 404 may be operatively linked via one or more electronic communication links (e.g., wireless communication link 122, 124, 126, and one or more communication links within the communication network). It will be appreciated that this is not intended to be limiting, and that the scope of this disclosure includes embodiments in which the network computing device 402 and the wireless device 404 may be operatively linked via some other communication medium.

The electronic storage 426, 430 may include non-transitory storage media that electronically stores information. The electronic storage media of electronic storage 426, 430 may include one or both of system storage that is provided integrally (i.e., substantially non-removable) with the network computing device 402 and the wireless device 404 and/or removable storage that is removably connectable to the network computing device 402 and the wireless device 404 via, for example, a port (e.g., a universal serial bus (USB) port, a firewire port, etc.) or a drive (e.g., a disk drive, etc.). Electronic storage 426, 430 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 426, 430 may include one or more virtual storage resources (e.g., cloud storage, a virtual private network, and/or other virtual storage resources). Electronic storage 426, 430 may store software algorithms, information determined by processor(s) 428, 432, information received from the network computing device 402 and the wireless device 404, or other information that enables the network computing device 402 and the wireless device 404 to function as described herein.

Processor(s) 428, 432 may be configured to provide information processing capabilities in the network computing device 402 and the wireless device 404. As such, the processor(s) 428, 432 may include one or more of a digital processor, an analog processor, a digital circuit designed to process information, an analog circuit designed to process information, a state machine, and/or other mechanisms for electronically processing information. Although the processor(s) 428, 432 are illustrated as single entities, this is for illustrative purposes only. In some embodiments, the processor(s) 428, 432 may include a plurality of processing units and/or processor cores. The processing units may be physically located within the same device, or processor(s) 428, 432 may represent processing functionality of a plurality of devices operating in coordination. The processor(s) 428, 432 may be configured to execute modules 408-414 and modules 436-446 and/or other modules by software; hardware; firmware; some combination of software, hardware, and/or firmware; and/or other mechanisms for configuring processing capabilities on processor(s) 428, 432. As used herein, the term “module” may refer to any component or set of components that perform the functionality attributed to the module. This may include one or more physical processors during execution of processor readable instructions, the processor readable instructions, circuitry, hardware, storage media, or any other components.

The description of the functionality provided by the different modules 408-414 and modules 436-442 described below is for illustrative purposes, and is not intended to be limiting, as any of modules 408-414 and modules 436-442 may provide more or less functionality than is described. For example, one or more of the modules 408-414 and modules 436-442 may be eliminated, and some or all of its functionality may be provided by other modules 408-414 and modules 436-442. As another example, the processor(s) 428, 432 may be configured to execute one or more additional modules that may perform some or all of the functionality attributed below to one of the modules 408-414 and modules 436-442.

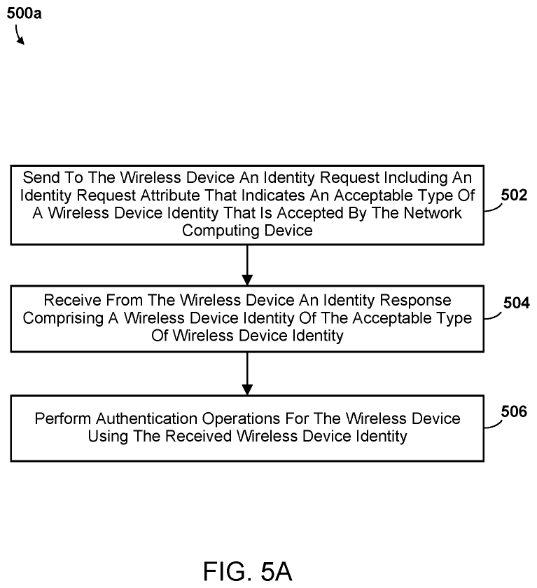

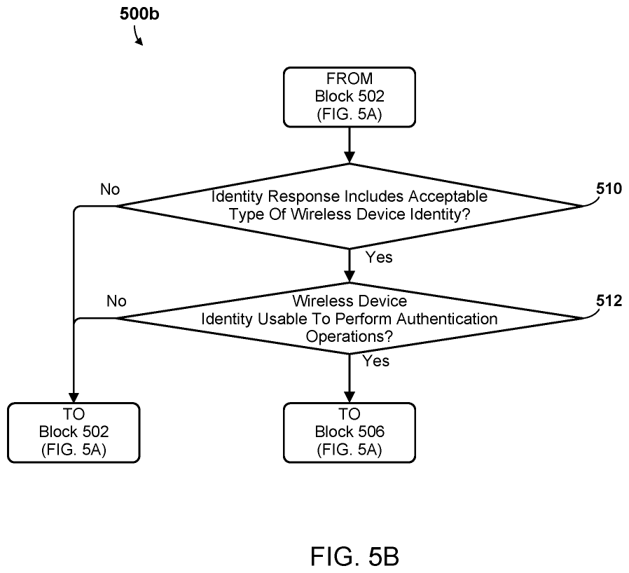

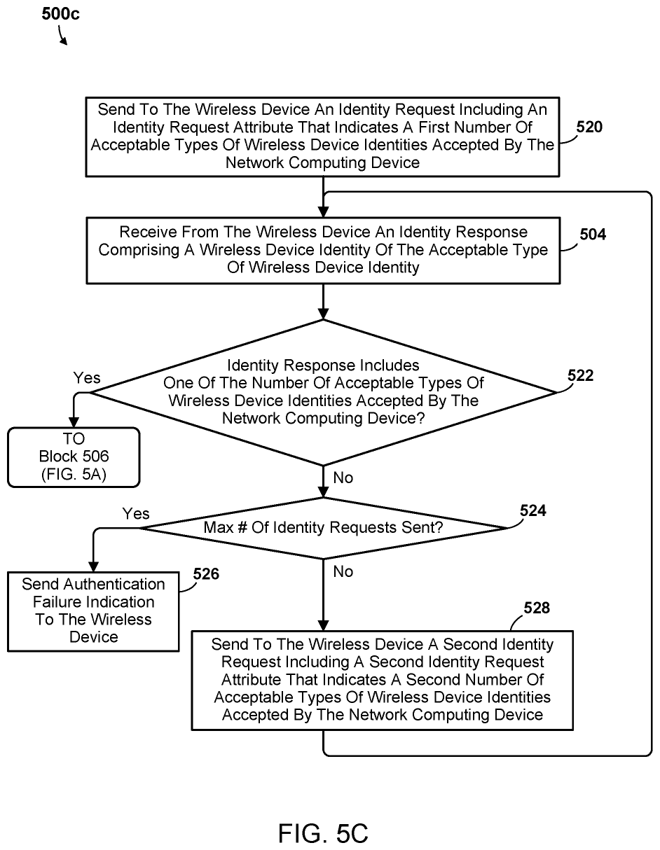

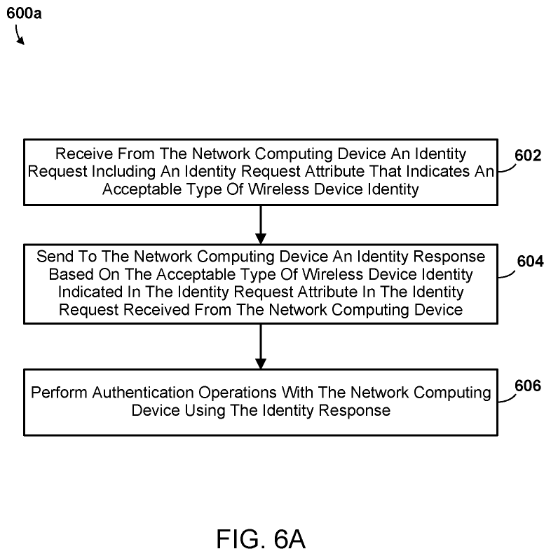

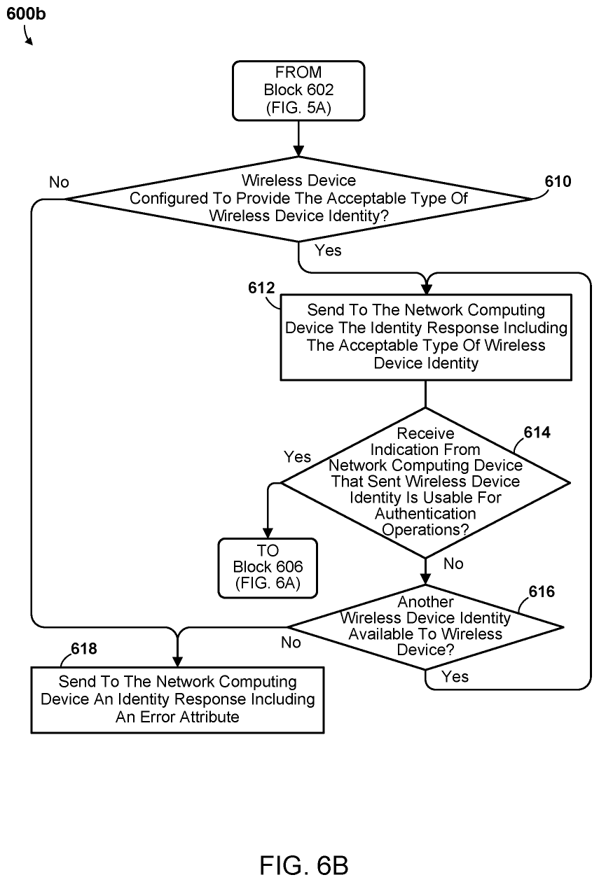

FIG. 5A is a process flow diagram illustrating a method 500a performed by a processor of a network computing device for authenticating a wireless device according to various embodiments. With reference to FIGS. 1-5A, the operations of the method 500a may be performed by a processor (such as the processor 210, 212, 214, 216, 218, 252, 260, 428) of a network computing device (such as the network computing device 140a, 200, 402).

In block 502, the processor may send to the wireless device an identity request including an identity request attribute that indicates an acceptable type of a wireless device identity that is preferred by the network computing device. In some embodiments, the acceptable type of wireless device identity may include an encrypted wireless device identity. In some embodiments, the identity request attribute may indicate one or more acceptable types of wireless device identity. Means for performing functions of the operations in block 502 may include the processor (e.g., 210, 212, 214, 216, 218, 252, 260, 428) and the communication interface (e.g., 268).

In block 504, the processor may receive from the wireless device an identity response that includes a wireless device identity of the acceptable type of wireless device identity. Means for performing functions of the operations in block 502 may include the processor (e.g., 210, 212, 214, 216, 218, 252, 260, 428) and the communication interface (e.g., 268).

In block 506, the processor may perform authentication operations for the wireless device using the received wireless device identity. Means for performing functions of the operations in block 506 may include the processor (e.g., 210, 212, 214, 216, 218, 252, 260, 428) and the communication interface (e.g., 268).

FIGS. 5B and 5C illustrate operations 500b and 500c that may be performed as part of the method 500a for authenticating a wireless device according to various embodiments. With reference to FIGS. 1-5C, the operations 500b and 500c may be performed by a processor (such as the processor 210, 212, 214, 216, 218, 252, 260, 428) of a network computing device network computing device (such as the network computing device 140a, 200, 402).

Referring to FIG. 5B, in some embodiments, following the performance of the operations of block 502 (FIG. 5A), the processor may determine whether the identity response includes the acceptable type of wireless device identity in determination block 510. Means for performing functions of the operations in determination block 510 may include the processor (e.g., 210, 212, 214, 216, 218, 252, 260, 428) and the communication interface (e.g., 268).

In response to determining that the identity response does not include the acceptable type of wireless device identity (i.e., determination block 510=“No”), the processor may again perform the operations of block 502 (FIG. 5A). For example, the identity response may include a type of wireless device identity that is not recognized, and the processor send another identity request. In some embodiments, the processor may send a second identity request for a specific wireless identity type.

For example, the network computing device may first request a more secure, but less-widely used, type of wireless device identity (e.g., an encrypted wireless device identity). Since various network computing devices and wireless device may be configured with, or configured to recognize, different wireless device identity types, it may be difficult to predict whether a wireless device identity type will be recognizable by the network computing device. For example, an encrypted wireless device identity may provide greater security, but may be less widely used or recognized than another wireless device identity, such as a permanent identity (e.g., IMSI). In some embodiments, to provide backward compatibility for older wireless devices, the network computing device may be configured to send a second, third, etc. identity request. In this manner, use of the identity request attribute increases the capability and flexibility of the network computing device to request different/additional wireless device identity types from the wireless device. Further, use of the identity request attribute increases the security of communications with wireless devices capable of using more secure wireless device identity types (e.g., an encrypted wireless device identity) while maintaining the ability (i.e., to provide backward compatibility) to request older or less secure wireless device identity types from older wireless device or wireless device not yet configured to use more secure types of wireless device identity.

In response to determining that the identity response does not include the acceptable type of wireless device identity (i.e., determination block 510=“Yes”), the processor may determine whether the received wireless device identity is usable to perform authentication operations in determination block 512. Means for performing functions of the operations in determination block 512 may include the processor (e.g., 210, 212, 214, 216, 218, 252, 260, 428).

In some embodiments, the processor may send an identity request for another wireless device identity because a first wireless device identity has expired, or is not recognized, or is not matched in a memory of the network computing device. In some embodiments, a wireless device identity may be generated for one-time use (e.g., a reauth identity) or for temporary use (e.g., a pseudonym identity), and a wireless device may respond with a wireless device identity that is no longer useable (e.g., because it has already been used, or a time period for its use has expired, or another suitable threshold condition). As another example, the identity response may include an encrypted wireless device identity, and decryption of the encrypted wireless device identity may fail. In such embodiments, the processor may determine that the identity response does not include a usable wireless device identity

In response to determining that the wireless device identity is not usable to perform authentication operations (i.e., determination block 512=“No”), the processor may again perform the operations of block 502 of the method 500 (FIG. 5A).

In response to determining that the wireless device identity is usable to perform authentication operations (i.e., determination block 512=“Yes”), the processor may perform the operations of block 506 of the method 500 (FIG. 5A).

Referring to FIG. 5C, in some embodiments, an example of sending to the wireless device an identity request including an identity request attribute that indicates an acceptable type of a wireless device identity that is preferred by the network computing device (e.g., block 502, FIG. 5A) may include sending to the wireless device an identity request including an identity request attribute that indicates a first number of preferred types of wireless device identities preferred by the network computing device in block 520. Means for performing functions of the operations in block 520 may include the processor (e.g., 210, 212, 214, 216, 218, 252, 260, 428) and the communication interface (e.g., 268).

The processor may perform the operations of block 504 (FIG. 5A) as described.

In determination block 522, the processor may determine whether the identity response includes one of the first number of preferred types of wireless device identities preferred by the network computing device. Means for performing functions of the operations in determination block 522 may include the processor (e.g., 210, 212, 214, 216, 218, 252, 260, 428).

In response to determining that the identity response includes one of the first number of preferred types of wireless device identities preferred by the network computing device (i.e., determination block 522=“Yes”), the processor may perform the operations of block 506 (FIG. 5A) as described.

In response to determining that the identity response does not include one of the first number of preferred types of wireless device identities preferred by the network computing device (i.e., determination block 522=“No”), the processor may determine whether the processor has sent a maximum number of identity requests to the wireless device in determination block 524. Means for performing functions of the operations in determination block 524 may include the processor (e.g., 210, 212, 214, 216, 218, 252, 260, 428).

In response to determining that the processor has sent a maximum number of identity requests to the wireless device (i.e., determination block 524=“Yes”), the processor may send an authentication failure indication to the wireless device in block 526. Means for performing functions of the operations in block 526 may include the processor (e.g., 210, 212, 214, 216, 218, 252, 260, 428) and the communication interface (e.g., 268).

In response to determining that the processor has not sent a maximum number of identity requests to the wireless device (i.e., determination block 524=“No”), the processor may send to the wireless device a second identity request including a second identity request attribute that indicates a second number of preferred types of wireless device identities preferred by the network computing device in block 528. In some embodiments, the second number of preferred types of wireless device identities may be less than the first number of preferred types of wireless identities preferred by the network computing device. In such embodiments, in this manner, the processor of the network computing device may reduce a number of possible preferred types of wireless identities from which the wireless device may choose, which may reduce a number of iterations performed by the processor of the network computing device, as well as by the wireless device, before the network computing device receives from the wireless device a wireless device identity that is preferred by the network computing device. Means for performing functions of the operations in block 528 may include the processor (e.g., 210, 212, 214, 216, 218, 252, 260, 428) and the communication interface (e.g., 268).

The processor may again perform the operations of determination block 504 as described.

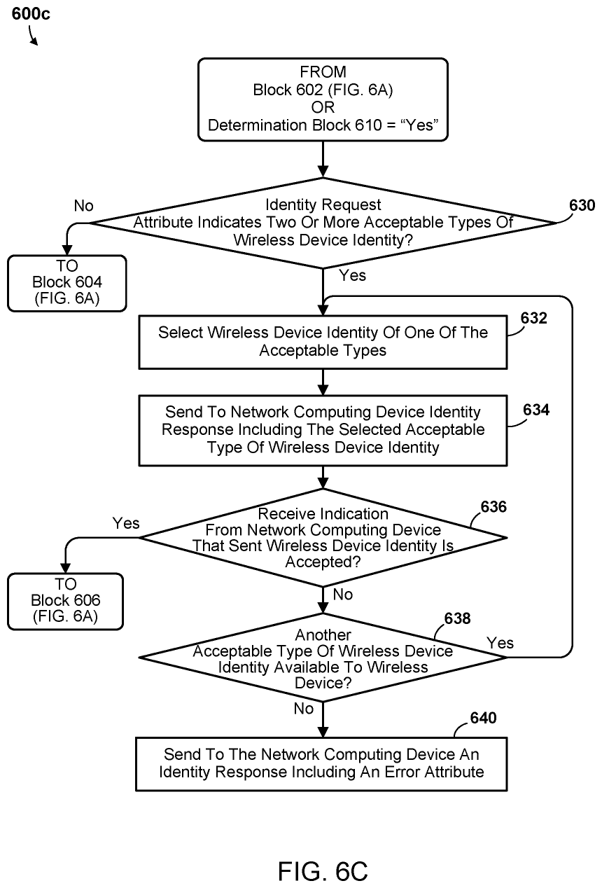

FIG. 6A is a process flow diagram illustrating a method 600a performed by a processor of a wireless device for authenticating with a network computing device according to various embodiments. With reference to FIGS. 1-6A, the operations of the method 600a may be performed by a processor (such as the processor 210, 212, 214, 216, 218, 252, 260, 432) of a wireless device (such as the wireless device 120a-120f, 200, 320, 404).

In block 602, the processor may receive from the network computing device an identity request including an identity request attribute that indicates an acceptable type of wireless device identity. In some embodiments, the identity request attribute in the received identity request may indicate an encrypted wireless device identity. In some embodiments, the identity request attribute may indicate one or more acceptable types of wireless device identity. In some embodiments, the identity request attribute may indicate one or more types of wireless device identity that are preferred by the network computing device. In some embodiments, the one or more types of wireless device identity may be indicated in an order of preference by the network computing device. Means for performing functions of the operations in block 602 may include the processor (e.g., 210, 212, 214, 216, 218, 252, 260, 432) and the wireless transceiver (e.g., 266).

In block 604, the processor may send to the network computing device an identity response based on the acceptable type of wireless device identity indicated in the identity request attribute in the identity request received from the network computing device. In some embodiments, the processor may send an identity response including one or more acceptable types of wireless device identity. In some embodiments, the wireless device may send the identity response including a type of wireless device identity that is preferred by the network computing device. Means for performing functions of the operations in block 604 may include the processor (e.g., 210, 212, 214, 216, 218, 252, 260, 432) and the wireless transceiver (e.g., 266).

In block 606, the processor may perform authentication operations with the network computing device using the identity response. Means for performing functions of the operations in block 606 may include the processor (e.g., 210, 212, 214, 216, 218, 252, 260, 432) and the wireless transceiver (e.g., 266).

FIG. 6B illustrates operations 600b that may be performed by a processor of wireless device as part of the method 600a for authenticating with a network computing device according to various embodiments. With reference to FIGS. 1-6B, the operations 600b may be performed by a processor (such as the processor 210, 212, 214, 216, 218, 252, 260, 432) of a wireless device (such as the wireless device 120a-120f, 200, 320, 404).

In some embodiments, following the operations in block 602 of the method 600a (FIG. 6A), the processor may determine whether the wireless device is configured to provide the acceptable type of wireless device identity in determination block 610. In some embodiments, the processor may determine whether the wireless device is configured to recognize the identity request attribute that indicates an acceptable type of wireless device identity. For example, the processor may determine whether the wireless device is configured to support the identity request attribute. In some embodiments, the processor may determine whether the wireless device is configured with the acceptable type of wireless device identity (i.e. the acceptable type of wireless device identity indicated in the identity request attribute). Means for performing functions of the operations in block 610 may include the processor (e.g., 210, 212, 214, 216, 218, 252, 260, 432).

In response to determining that the wireless device is not configured to provide the acceptable type of wireless device identity (i.e., determination block 610=“No”), the processor may send to the network computing device an error attribute in block 618. For example, the processor may send to the network computing device an identity response including an error attribute (or another suitable indication of an error).

In response to determining that the wireless device is configured to provide the acceptable type of wireless device identity in determination (i.e., determination block 610=“Yes”), the processor may send to the network computing device the identity response including the acceptable type of wireless device identity in block 612. Means for performing functions of the operations in block 612 may include the processor (e.g., 210, 212, 214, 216, 218, 252, 260, 432) and the wireless transceiver (e.g., 266).

In determination block 614, the processor may determine whether the wireless device receives an indication from the network computing device that the wireless device identity is usable for authentication operations. In some embodiments, the processor may receive another identity request from the network computing device signifying that the wireless device identity is not usable for authentication operations. In some embodiments, the new identity request may indicate, for example, that a one-time-use wireless device identity has already been used, that a time period during which the wireless device identity may be used has expired, that the wireless device identity is not recognized by the network computing device, or that the wireless device identity is not matched in a memory of the network computing device. In some embodiments, the new identity request may be sent by the network computing device, for example, if a one-time-use wireless device identity has already been used, if a time period during which the wireless device identity may be used has expired, if the wireless device identity is not recognized by the network computing device, or if the wireless device identity is not matched in a memory of the network computing device. In some embodiments, the receipt of another identity request may indicate, for example, that decryption of an encrypted wireless device identity has failed. Means for performing functions of the operations in determination block 614 may include the processor (e.g., 210, 212, 214, 216, 218, 252, 260, 432) and the wireless transceiver (e.g., 266).

In response to determining that the wireless device identity is usable for authentication operations (i.e., determination block 614=“Yes”), the processor may perform the operations of block 606 of the method 600a (FIG. 6A) as described.

In response to determining that the wireless device identity is not usable for authentication operations (i.e., determination block 614=“No”), the processor may determine whether another wireless device identity is available to the wireless device in determination block 616. For example, the processor may determine whether the wireless device is configured with another wireless device identity. In some embodiments, the processor may determine whether the wireless device is configured with another wireless device identity that is identified as acceptable in the identity request attribute. Means for performing functions of the operations in determination block 616 may include the processor (e.g., 210, 212, 214, 216, 218, 252, 260, 432) and the wireless transceiver (e.g., 266).

In response to determining that another wireless device identity is available to the wireless device (i.e., determination block 616=“Yes”), the processor may again perform the operations of block 612.

In response to determining that another wireless device identity is not available to the wireless device (i.e., determination block 616=“No”), the processor may send to the network computing device an error attribute in block 618. For example, the processor may send to the network computing device an identity response including an error attribute (or another suitable indication of an error).

FIG. 6C illustrates operations 600c that may be performed by a processor of wireless device as part of the method 600a for authenticating with a network computing device according to some embodiments. With reference to FIGS. 1-6C, the operations 600c may be performed by a processor (such as the processor 210, 212, 214, 216, 218, 252, 260, 432) of a wireless device (such as the wireless device 120a-120f, 200, 320, 404).

Following the performance of the operations of block 602 (FIG. 6A) or in response to determining that the wireless device is configured to provide the acceptable type of wireless device identity in determination (i.e., determination block 610=“Yes”), the processor may determine whether the identity request attribute included in the identity request indicates two or more acceptable types of wireless device identity in determination block 630. Means for performing functions of the operations in determination block 630 may include the processor (e.g., 210, 212, 214, 216, 218, 252, 260, 432).

In response to determining that the identity request attribute included in the identity request does not indicate two or more acceptable types of wireless device identity (i.e., determination block 630=“No”), the processor may perform the operations of block 604 of the method 600a (FIG. 6A) as described.

In response to determining that the identity request attribute included in the identity request indicates two or more acceptable types of wireless device identity (i.e., determination block 630=“Yes”), the processor may select (e.g., from a memory of the wireless device) a wireless device identity that is one of the acceptable types of wireless device identity. In some embodiments, the identity request attribute may indicate the two or more acceptable types of wireless device identity in a list or order, such as an order of preference. In some embodiments, the wireless device may select a most preferred type of wireless device identity as indicated by the identity request attribute (e.g., where the attribute indicates the acceptable types of wireless device identities in an order of preference). Means for performing functions of the operations in determination block 632 may include the processor (e.g., 210, 212, 214, 216, 218, 252, 260, 432).

In block 634, the processor may send to the network computing device an identity response including the selected acceptable type of wireless device identity in block 634. Means for performing functions of the operations in block 634 may include the processor (e.g., 210, 212, 214, 216, 218, 252, 260, 432) and the wireless transceiver (e.g., 266).

In determination block 636, the processor may determine whether the wireless device receives an indication from the network computing device that the sent wireless device identity is accepted. Means for performing functions of the operations in determination block 636 may include the processor (e.g., 210, 212, 214, 216, 218, 252, 260, 432) and the wireless transceiver (e.g., 266).

In response to determining that the wireless device has received an indication from the network computing device that the sent wireless device identity is accepted (i.e., determination block 636=“Yes”), the processor may perform the operations of block 606 of the method 600a (FIG. 6A) as described.

In response to determining that the wireless device has received an indication from the network computing device that the sent wireless device identity is not accepted (i.e., determination block 636=“No”), the processor may determine whether another acceptable type of wireless device identity is available to the wireless device in determination block 638. For example, the processor may determine whether the wireless device is configured with another wireless device identity that is indicated as acceptable in the identity request attribute. Means for performing functions of the operations in determination block 638 may include the processor (e.g., 210, 212, 214, 216, 218, 252, 260, 432) and the wireless transceiver (e.g., 266).

In response to determining that another wireless device identity is available to the wireless device (i.e., determination block 638=“Yes”), the processor may again perform the operations of block 632. In some embodiments, the processor may select a next wireless device identity of a type that the identity request attribute indicates in an order of preference. In this manner, the wireless device may iterate through a list or order of preference of the types of wireless device identities.

In response to determining that another wireless device identity is not available to the wireless device (i.e., determination block 638=“No”), the processor may send to the network computing device an error attribute in block 640. For example, the processor may send to the network computing device an identity response including an error attribute (or another suitable indication of an error). Means for performing functions of the operations in determination block 640 may include the processor (e.g., 210, 212, 214, 216, 218, 252, 260, 432) and the wireless transceiver (e.g., 266).

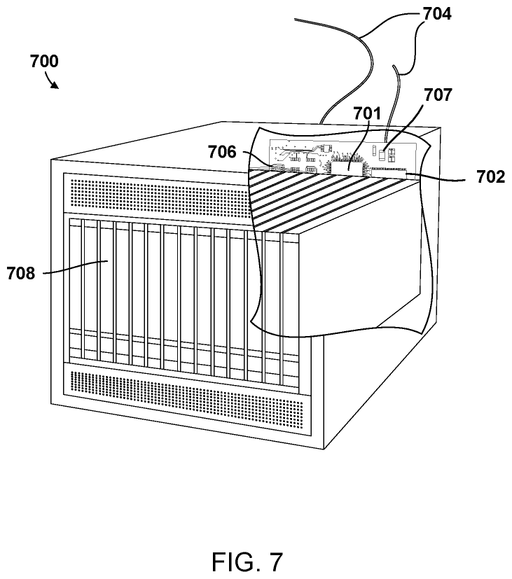

FIG. 7 is a component block diagram of a network computing device suitable for use with various embodiments. Such network computing devices (e.g., base station 110a-110d, 350, 402) may include at least the components illustrated in FIG. 7. With reference to FIGS. 1-7, the network computing device 700 may typically include a processor 701 coupled to volatile memory 702 and a large capacity nonvolatile memory, such as a disk drive 708. The network computing device 700 also may include a peripheral memory access device 706 such as a floppy disc drive, compact disc (CD) or digital video disc (DVD) drive coupled to the processor 701. The network computing device 700 also may include network access ports 704 (or interfaces) coupled to the processor 701 for establishing data connections with a network, such as the Internet or a local area network coupled to other system computers and servers. The network computing device 700 may include one or more antennas 707 for sending and receiving electromagnetic radiation that may be connected to a wireless communication link. The network computing device 700 may include additional access ports, such as USB, Firewire, Thunderbolt, and the like for coupling to peripherals, external memory, or other devices.

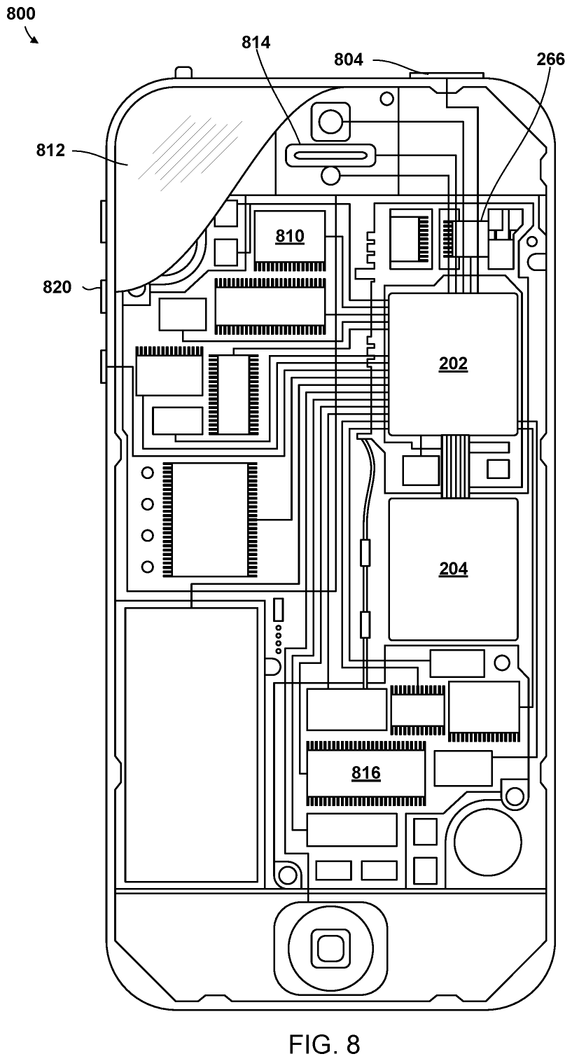

FIG. 8 is a component block diagram of a wireless device 800 suitable for use with various embodiments. With reference to FIGS. 1-8, various embodiments may be implemented on a variety of wireless devices 800 (for example, the wireless device 120a-120e, 200, 320, 404), an example of which is illustrated in FIG. 8 in the form of a smartphone. The wireless device 800 may include a first SOC 202 (for example, a SOC-CPU) coupled to a second SOC 204 (for example, a 5G capable SOC). The first and second SOCs 202, 204 may be coupled to internal memory 816, a display 812, and to a speaker 814. Additionally, the wireless device 800 may include an antenna 804 for sending and receiving electromagnetic radiation that may be connected to a wireless transceiver 266 coupled to one or more processors in the first and/or second SOCs 202, 204. Wireless device 800 may include menu selection buttons or rocker switches 820 for receiving user inputs.

The wireless device 800 wireless device 800 may include a sound encoding/decoding (CODEC) circuit 810, which digitizes sound received from a microphone into data packets suitable for wireless transmission and decodes received sound data packets to generate analog signals that are provided to the speaker to generate sound. One or more of the processors in the first and second SOCs 202, 204, wireless transceiver 266 and CODEC 810 may include a digital signal processor (DSP) circuit (not shown separately).

The processors of the network computing device 700 and the wireless device 800 may be any programmable microprocessor, microcomputer or multiple processor chip or chips that can be configured by software instructions (applications) to perform a variety of functions, including the functions of some implementations described below. In some wireless devices, multiple processors may be provided, such as one processor within an SOC 204 dedicated to wireless communication functions and one processor within an SOC 202 dedicated to running other applications. Software applications may be stored in the memory 702, 816 before they are accessed and loaded into the processor. The processors may include internal memory sufficient to store the application software instructions.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, or a computer. By way of illustration, both an application running on a wireless device and the wireless device may be referred to as a component. One or more components may reside within a process or thread of execution and a component may be localized on one processor or core or distributed between two or more processors or cores. In addition, these components may execute from various non-transitory computer readable media having various instructions or data structures stored thereon. Components may communicate by way of local or remote processes, function or procedure calls, electronic signals, data packets, memory read/writes, and other known network, computer, processor, or process related communication methodologies.

A number of different cellular and mobile communication services and standards are available or contemplated in the future, all of which may implement and benefit from the various embodiments. Such services and standards include, e.g., third generation partnership project (3GPP), long term evolution (LTE) systems, third generation wireless mobile communication technology (3G), fourth generation wireless mobile communication technology (4G), fifth generation wireless mobile communication technology (5G) as well as later generation 3GPP technology, global system for mobile communications (GSM), universal mobile telecommunications system (UMTS), 3GSM, general packet radio service (GPRS), code division multiple access (CDMA) systems (e.g., cdmaOne, CDMA1020™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the methods and operations 500a, 500b, 500c, 600a, and 600b may be substituted for or combined with one or more operations of the methods and operations 500a, 500b, 500c, 600a, and 600b.

Implementation examples are described in the following paragraphs. While some of the following implementation examples are described in terms of example methods, further example implementations may include: the example methods discussed in the following paragraphs implemented by a UE including a processor configured with processor-executable instructions to perform operations of the methods of the following implementation examples; the example methods discussed in the following paragraphs implemented by a UE including means for performing functions of the methods of the following implementation examples; and the example methods discussed in the following paragraphs may be implemented as a non-transitory processor-readable storage medium having stored thereon processor-executable instructions configured to cause a processor of a UE to perform the operations of the methods of the following implementation examples.

Example 1. A method performed by a processor of a network computing device for authenticating a wireless device, including: sending to the wireless device an identity request including an identity request attribute that indicates an acceptable type of a wireless device identity that is accepted by the network computing device; receiving from the wireless device an identity response including a wireless device identity of the acceptable type of wireless device identity; and performing authentication operations for the wireless device using the received wireless device identity.

Example 2. The method of example 1, wherein the acceptable type of wireless device identity includes an encrypted wireless device identity.

Example 3. The method of any of examples 1-2, wherein the identity request attribute indicates one or more wireless device identities that are preferred by the network computing device.

Example 4. The method of any of examples 1-3, further including determining whether the identity response includes the acceptable type of wireless device identity, wherein performing authentication operations for the wireless device using the received wireless device identity includes performing authentication operations for the wireless device using the received wireless device identity in response to determining that the identity response includes the acceptable type of wireless device identity.

Example 5. The method of any of examples 1-3, further including determining whether the wireless device identity is usable to perform authentication operations, wherein performing authentication operations for the wireless device using the received wireless device identity includes performing authentication operations for the wireless device using the received wireless device identity in response to determining that the wireless device identity is usable to perform authentication operations.

Example 6. The method of any of examples 1-3, wherein: sending to the wireless device an identity request including an identity request attribute that indicates an acceptable type of a wireless device identity that is accepted by the network computing device includes sending to the wireless device an identity request including an identity request attribute that indicates a first number of preferred types of wireless device identities preferred by the network computing device; receiving from the wireless device an identity response including a wireless device identity of the acceptable type of wireless device identity includes determining whether the identity response includes one of the first number of preferred types of wireless device identities preferred by the network computing device; and performing authentication operations for the wireless device using the received wireless device identity includes performing authentication operations for the wireless device using the received wireless device identity in response to determining that the identity response includes one of the first number of preferred types of wireless device identities.

Example 7. The method of example 6, further including sending to the wireless device a second identity request including a second identity request attribute that indicates a second number of preferred types of wireless device identities preferred by the network computing device in response to determining that the identity response does not include one of the first number of preferred types of wireless device identities preferred by the network computing device, wherein the second number of preferred types of wireless device identities is less than the first number of preferred types of wireless identities preferred by the network computing device.

Example 8. The method of any of examples 1-7, wherein: sending to the wireless device an identity request including an identity request attribute that indicates an acceptable type of a wireless device identity that is preferred by the network computing device includes sending to the wireless device an identity request including an identity request attribute that indicates an acceptable type of a wireless device identity that is preferred by the network computing device other than a permanent wireless device identity, and receiving from the wireless device an identity response including a wireless device identity of the acceptable type of wireless device identity includes receiving from the wireless device an identity response including a wireless device identity other than the permanent wireless device identity.

Example 9. A method performed by a processor of a wireless device for authenticating with a network computing device, including: receiving from the network computing device an identity request including an identity request attribute that indicates an acceptable type of wireless device identity; sending to the network computing device an identity response based on the acceptable type of wireless device identity indicated in the identity request attribute in the identity request received from the network computing device; and performing authentication operations with the network computing device using the identity response.

Example 10. The method of example 9, wherein receiving from the network computing device an identity request including an identity request attribute that indicates an acceptable type of wireless device identity includes determining that the identity request attribute in the received identity request indicates an encrypted wireless device identity.

Example 11. The method of either example 9 or 10, wherein sending to the network computing device an identity response based on the acceptable type of wireless device identity indicated in the identity request attribute in the identity request received from the network computing device includes: determining whether the wireless device is configured to provide the acceptable type of wireless device identity; and sending to the network computing device the identity response including the acceptable type of wireless device identity in response to determining that the wireless device is configured to provide the acceptable type of wireless device identity.

Example 12. The method of example 11, further including sending to the network computing device an identity response including an error attribute in response to determining that the wireless device is not configured to provide the acceptable type of wireless device identity.

Example 13. The method of any of examples 9-12, further including: determining whether the wireless device has received from the network computing device an indication that the sent wireless device identity is usable for authentication operations; and sending to the network computing device another identity response including another acceptable type of wireless device identity in response to determining that the wireless device has received an indication from the network computing device that the sent wireless device identity is not usable for authentication operations.

Example 14. The method of any of examples 9-13, further including: determining whether the identity request attribute indicates two or more acceptable types of wireless device identities; and selecting a wireless device identity of one of the acceptable types of wireless device identities in response to determining that the identity request attribute indicates two or more acceptable types of wireless device identities, wherein sending to the network computing device an identity response based on the acceptable type of wireless device identity indicated in the identity request attribute in the identity request received from the network computing device includes sending the selected wireless device identity to the network computing device.

Example 15. The method of example 14, further including: determining whether the wireless device has received from the network computing device an indication that the sent wireless device identity is accepted; selecting another wireless device identity of one of the acceptable types of wireless device identities in response to determining that the wireless device has received from the network computing device an indication that the sent wireless device identity is not accepted; and sending the selected another wireless device identity to the network computing device.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method performed by a processor of a network computing device for authenticating a wireless device, comprising:
sending to the wireless device an identity request including an identity request attribute that indicates an acceptable type of a wireless device identity that is accepted by the network computing device;
receiving from the wireless device an identity response comprising a wireless device identity of the acceptable type of wireless device identity; and
performing authentication operations for the wireless device using the received wireless device identity.

2. The method of claim 1, wherein the acceptable type of wireless device identity comprises an encrypted wireless device identity.

3. The method of claim 1, wherein the identity request attribute indicates one or more wireless device identities that are preferred by the network computing device.

4. The method of claim 1, further comprising determining whether the identity response includes the acceptable type of wireless device identity,
wherein performing authentication operations for the wireless device using the received wireless device identity comprises performing authentication operations for the wireless device using the received wireless device identity in response to determining that the identity response includes the acceptable type of wireless device identity.

5. The method of claim 1, further comprising determining whether the wireless device identity is usable to perform authentication operations,
wherein performing authentication operations for the wireless device using the received wireless device identity comprises performing authentication operations for the wireless device using the received wireless device identity in response to determining that the wireless device identity is usable to perform authentication operations.

6. The method of claim 1, wherein:
sending to the wireless device an identity request including an identity request attribute that indicates an acceptable type of a wireless device identity that is accepted by the network computing device comprises sending to the wireless device an identity request including an identity request attribute that indicates a first number of preferred types of wireless device identities preferred by the network computing device;
receiving from the wireless device an identity response comprising a wireless device identity of the acceptable type of wireless device identity comprises determining whether the identity response includes one of the first number of preferred types of wireless device identities preferred by the network computing device; and
performing authentication operations for the wireless device using the received wireless device identity comprises performing authentication operations for the wireless device using the received wireless device identity in response to determining that the identity response includes one of the first number of preferred types of wireless device identities.

7. The method of claim 6, further comprising sending to the wireless device a second identity request including a second identity request attribute that indicates a second number of preferred types of wireless device identities preferred by the network computing device in response to determining that the identity response does not include one of the first number of preferred types of wireless device identities preferred by the network computing device, wherein the second number of preferred types of wireless device identities is less than the first number of preferred types of wireless identities preferred by the network computing device.

8. The method of claim 1, wherein:
sending to the wireless device an identity request including an identity request attribute that indicates an acceptable type of a wireless device identity that is preferred by the network computing device comprises sending to the wireless device an identity request including an identity request attribute that indicates an acceptable type of a wireless device identity that is preferred by the network computing device other than a permanent wireless device identity, and
receiving from the wireless device an identity response comprising a wireless device identity of the acceptable type of wireless device identity comprises receiving from the wireless device an identity response including a wireless device identity other than the permanent wireless device identity.

9. A method performed by a processor of a wireless device for authenticating with a network computing device, comprising:
receiving from the network computing device an identity request including an identity request attribute that indicates an acceptable type of wireless device identity;
sending to the network computing device an identity response based on the acceptable type of wireless device identity indicated in the identity request attribute in the identity request received from the network computing device; and
performing authentication operations with the network computing device using the identity response.

10. The method of claim 9, wherein receiving from the network computing device an identity request including an identity request attribute that indicates an acceptable type of wireless device identity comprises determining that the identity request attribute in the received identity request indicates an encrypted wireless device identity.

11. The method of claim 9, wherein sending to the network computing device an identity response based on the acceptable type of wireless device identity indicated in the identity request attribute in the identity request received from the network computing device comprises:
determining whether the wireless device is configured to provide the acceptable type of wireless device identity; and
sending to the network computing device the identity response including the acceptable type of wireless device identity in response to determining that the wireless device is configured to provide the acceptable type of wireless device identity.

12. The method of claim 11, further comprising sending to the network computing device an identity response including an error attribute in response to determining that the wireless device is not configured to provide the acceptable type of wireless device identity.

13. The method of claim 9, further comprising:
determining whether the wireless device has received from the network computing device an indication that the sent wireless device identity is usable for authentication operations; and
sending to the network computing device another identity response including another acceptable type of wireless device identity in response to determining that the wireless device has received an indication from the network computing device that the sent wireless device identity is not usable for authentication operations.

14. The method of claim 9, further comprising:
determining whether the identity request attribute indicates two or more acceptable types of wireless device identities; and
selecting a wireless device identity of one of the acceptable types of wireless device identities in response to determining that the identity request attribute indicates two or more acceptable types of wireless device identities,
wherein sending to the network computing device an identity response based on the acceptable type of wireless device identity indicated in the identity request attribute in the identity request received from the network computing device comprises sending the selected wireless device identity to the network computing device.

15. The method of claim 14, further comprising:
determining whether the wireless device has received from the network computing device an indication that the sent wireless device identity is accepted;
selecting another wireless device identity of one of the acceptable types of wireless device identities in response to determining that the wireless device has received from the network computing device an indication that the sent wireless device identity is not accepted; and
sending the selected another wireless device identity to the network computing device.

16. A network computing device, comprising:
a processor configured with processor executable instructions to:
send to the wireless device an identity request including an identity request attribute that indicates an acceptable type of a wireless device identity that is accepted by the network computing device;
receive from the wireless device an identity response comprising a wireless device identity of the acceptable type of wireless device identity; and
perform authentication operations for the wireless device using the received wireless device identity.

17. The network computing device of claim 16, wherein the processor is further configured with processor-executable instructions such that the acceptable type of wireless device identity comprises an encrypted wireless device identity.

18. The network computing device of claim 16, wherein the processor is further configured with processor-executable instructions such that the identity request attribute indicates one or more wireless device identities that are preferred by the network computing device.

19. The network computing device of claim 16, wherein the processor is further configured with processor-executable instructions to:
determine whether the identity response includes the acceptable type of wireless device identity; and
perform authentication operations for the wireless device using the received wireless device identity in response to determining that the identity response includes the acceptable type of wireless device identity.

20. The network computing device of claim 16, wherein the processor is further configured with processor-executable instructions to:
determine whether the wireless device identity is usable to perform authentication operations; and
perform authentication operations for the wireless device using the received wireless device identity in response to determining that the wireless device identity is usable to perform authentication operations.

21. The network computing device of claim 16, wherein the processor is further configured with processor-executable instructions to:
send to the wireless device an identity request including an identity request attribute that indicates a first number of preferred types of wireless device identities preferred by the network computing device;
determine whether the identity response includes one of the first number of preferred types of wireless device identities preferred by the network computing device; and
perform authentication operations for the wireless device using the received wireless device identity in response to determining that the identity response includes one of the first number of preferred types of wireless device identities.

22. The network computing device of claim 21, wherein the processor is further configured with processor-executable instructions to send to the wireless device a second identity request including a second identity request attribute that indicates a second number of preferred types of wireless device identities preferred by the network computing device, wherein the second number of preferred types of wireless device identities is less than the first number of preferred types of wireless identities preferred by the network computing device, in response to determining that the identity response does not include one of the first number of preferred types of wireless device identities preferred by the network computing device.

23. The network computing device of claim 16, wherein the processor is further configured with processor-executable instructions to:
send to the wireless device an identity request including an identity request attribute that indicates an acceptable type of a wireless device identity that is preferred by the network computing device other than a permanent wireless device identity; and
receive from the wireless device an identity response including a wireless device identity other than the permanent wireless device identity.

24. A wireless device, comprising:
a processor configured with processor executable instructions to:
receive from a network computing device an identity request including an identity request attribute that indicates an acceptable type of wireless device identity;
send to the network computing device an identity response based on the acceptable type of wireless device identity indicated in the identity request attribute in the identity request received from the network computing device; and
perform authentication with the network computing device using the identity response.

25. The wireless device of claim 24, wherein the processor is further configured with processor-executable instructions to determine whether the identity request attribute in the received identity request indicates an encrypted wireless device identity.

26. The wireless device of claim 24, wherein the processor is further configured with processor-executable instructions to:
determine whether the wireless device is configured to provide the acceptable type of wireless device identity; and
send to the network computing device the identity response including the acceptable type of wireless device identity in response to determining that the wireless device is configured to provide the acceptable type of wireless device identity.

27. The wireless device of claim 26, wherein the processor is further configured with processor-executable instructions to send to the network computing device an identity response including an error attribute in response to determining that the wireless device is not configured to provide the acceptable type of wireless device identity.

28. The wireless device of claim 24, wherein the processor is further configured with processor-executable instructions to:
determine whether the wireless device has received an indication from the network computing device that the sent wireless device identity is usable for authentication operations; and
send to the network computing device another identity response including another acceptable type of wireless device identity in response to determining that the wireless device has received an indication from the network computing device that the sent wireless device identity is not usable for authentication operations.

29. The wireless device of claim 24, wherein the processor is further configured with processor-executable instructions to:
determine whether the identity request attribute indicates two or more acceptable types of wireless device identities;
select a wireless device identity of one of the acceptable types of wireless device identities in response to determining that the identity request attribute indicates two or more acceptable types of wireless device identities; and
send the selected wireless device identity to the network computing device.

30. The wireless device of claim 24, wherein the processor is further configured with processor-executable instructions to:
determine whether the wireless device has received from the network computing device an indication that the sent wireless device identity is accepted;
select another wireless device identity of one of the acceptable types of wireless device identities in response to determining that the wireless device has received from the network computing device an indication that the sent wireless device identity is not accepted; and
send the selected another wireless device identity to the network computing device.
